(19) United States
(12) Patent Application Publication
(10) Pub. No.: US 2015/0113815 A1
(43) Pub. Date: Apr. 30, 2015

(54) Compact Power Tool Handle

(71) Applicant: Black & Decker Inc., Newark, DE (US)

(72) Inventors: Jason C. McRoberts, Red Lion, PA (US); David A. Miller, Baltimore, MD (US); Oleksiy P. Sergyeyenko, Baldwin (DE)

(73) Assignee: Black & Decker Inc., Newark, DE (US)

(21) Appl. No.: 14/480,385

(22) Filed: Sep. 8, 2014

Related U.S. Application Data
(63) Continuation-in-part of application No. 14/063,503, filed on Oct. 25, 2013.

(51) Int. Cl. B25F 5/02; H01C 10/14; B23D 49/16; H02P 23/00

(52) U.S. Cl. CPC B25F 5/02; H02P 23/0063; H01C 10/14; B23D 49/162
USPC 30/392; 173/170

(57) ABSTRACT

A power tool can have a compact power tool handle. A compact power tool handle can be used in a jigsaw, or any other power tool with a handle. Optionally, the power tool can have a compact power tool handle which has an AC compact variable switch which can control the speed of a motor of the power tool.

### CROSS-REFERENCE TO RELATED APPLICATIONS

This patent application is a continuation-in-part of and claims the benefit of the filing date of copending U.S. patent application Ser. No. 14/063,503 entitled “Handheld Power Tool With Compact AC Switch” filed on Oct. 25, 2013, and having confirmation number 4113.

### FIELD OF THE INVENTION

The present disclosure relates to a power tool and more particularly to a handheld power tool having a compact handle.

### INCORPORATION BY REFERENCE

This patent application incorporates by reference in its entirety copending U.S. patent application Ser. No. 14/063,503 entitled “Handheld Power Tool With Compact AC Switch” filed on Oct. 25, 2013, and having confirmation number 4113.

This patent application incorporates by reference in its entirety U.S. Pat. No. 8,555,516 entitled “Pivoting Blade Retainer” issued Oct. 15, 2013.

This patent application incorporates by reference in its entirety U.S. Pat. No. 8,776,383 entitled “Clamp For Reciprocating Saw” issued Jul. 15, 2014.

This patent application incorporates by reference in its entirety U.S. Pat. No. 8,438,741 entitled “Lock For Power Tool” issued May 14, 2013.

This patent application incorporates by reference in its entirety copending U.S. patent application Ser. No. 13/713,086 entitled “Electric Supply Cable Sheath For A Power Tool” filed Dec. 13, 2012.

### BACKGROUND OF THE INVENTION

This disclosure regards power tools and more particularly handheld power tools which can be powered by electricity. Such power tools can be those used for example but are not limited to those used in residential and commercial construction, carpentry, repair, maintenance, assembly projects, yard work, landscaping, and other activities. A trigger of a power tool can be disposed along a handle and can trigger a switch which can cause an electric motor to drive a power tool.

The trigger switch can include a printed circuit board for controlling the electricity that is supplied to the electric motor. Current trigger switch configurations have a problem in that the printed circuit board takes up significant space within the handle and the handle must be designed to have a large volume to accommodate the width of the printed circuit board, its components and the trigger switch cover. This limits the packaging possibilities of power tools and dictates the large size and design of the handle and housing. There is a strong need for a small, comfortable, safe handle that properly accommodates the grip of an operator's hand.

### SUMMARY OF THE INVENTION

This section provides a general summary of the technology and is not a comprehensive disclosure of its full scope or all of its features.

In an embodiment, a power tool can have a handle having a grip portion which is configured at a distance from a body portion providing a finger clearance between the grip portion and the body portion; and a handle having a trigger which triggers an AC compact variable switch which controls the speed of a motor. The handle can also have a handle width of 60 mm or less measured along a trigger travel axis.

In an embodiment, the power tool can have a switch assembly which has a trigger which triggers the AC compact variable switch; the switch assembly can have an extended state in which the trigger is in an extended position and a depressed state in which the trigger is depressed at least in part along a trigger travel distance; and the handle width can have a value of 50 mm or less when the switch assembly is in the depressed state.

In an embodiment, the power tool can have a value of 40 mm or less when the switch assembly is in the depressed state. In an embodiment, the handle width can have a value of 60 mm or less when the switch is in the extended state and the handle width can have a value of 40 mm or less when the switch assembly is in the depressed state. Optionally, the power tool can have a finger clearance which is 50 mm or less measured along a grip axis.

In an embodiment, the power tool can have a handle height which is 100 mm or less measured along a grip axis of a grip assembly. The grip assembly can contain at least a portion of an AC compact variable switch. The handle can have a handle width which is 50 mm or less measured along a grip axis when the switch assembly is in the depressed state. The handle can also have a switch assembly having a trigger travel axis which passes through the trigger and the AC compact variable switch; and the switch assembly can have a trigger travel distance which is 3 mm or greater, or 4 mm or greater, or 5 mm or greater, or 6 mm or greater, or 7 mm or greater, or 10 mm or greater, or 20 mm or greater.

In an embodiment, the power tool can have a handle which has an average depressed grip volume of 75000 mm̂3 or less (75 cm̂3 or less), or 60000 mm̂3 or less (60 cm̂3 or less), or 50000 mm̂3 or less (50 cm̂3 or less), or 45000 mm̂3 or less (45 cm̂3 or less).

In an embodiment, the power tool can have a wireless communication device which can transmit data regarding the power tool for reporting, monitoring or processing.

In an embodiment, the power tool can have a handle and a body portion, as well as a variable speed controller which can control a speed of a motor. The handle can have a trigger and a compact AC switch which is switched by the trigger. The switch assembly can have an extended state and a depressed state. The handle can have a depressed grip width of 60 mm or less when the switch assembly is in the depressed state. The handle can have a trigger finger clearance of 10 mm or greater, or 25 mm or greater, or 30 mm or greater. The handle can have a handle finger clearance of 10 mm or greater, or 15 mm or greater, or 20 mm or greater, or 25 mm or greater, or 30 mm or greater, or 50 mm or greater. The handle can have a finger clearance between a portion of the power tool body and a portion of the handle of 10 mm or greater, or 15 mm or greater, or 20 mm or greater, or 25 mm or greater, or 30 mm or greater, 40 mm or greater, or 50 mm or greater, or 100 mm or greater, or 150 mm or greater.

When the switch assembly is in the depressed state, the power tool can have a depressed grip circumference of 3000 mm or less, or 2800 mm or less, or 2500 mm or 2000 mm or less.

When the switch assembly is in the depressed state, the power tool can have a depressed grip perimeter of 2000 mm or less, or 1000 mm or less, or 500 mm, or less, or 250 mm or less, or 200 mm or less, or 150 mm or less, or 125 mm or less, or 115 mm or less, or 100 mm or less, or 75 mm or less, or 50 mm or less. In an embodiment, the depressed grip perimeter can be in a range of 50 mm to 1000 mm, or 50 mm to 500 mm, or 50 mm to 250 mm, or 50 mm to 150 mm, or 50 mm to 100 mm, or 50 mm to 75 mm, or 75 mm to 200 mm.

In an embodiment, a power tool can have a first depressed grip circumference and a second depressed grip circumference. The first depressed grip circumference and the second depressed grip circumference can each have having a value of 3000 mm or less, or 2000 mm or less, or 1000 mm or less, or 500 mm or less, when the switch assembly is in the depressed state. The first depressed grip circumference can be different from the second depressed grip circumference, or they can have the same or similar values.

In an embodiment, a power tool can have a handle which has an average depressed grip volume which is 80000 mm̂3 or less (80 cm̂3 or less), or 75000 mm̂3 or less (75 cm̂3 or less), or 65000 mm̂3 or less (65 cm̂3 or less), or 60000 mm̂3 or less (60 cm̂3 or less), or 50000 mm̂3 or less (50 cm̂3 or less), or 40000 mm̂3 or less (40 cm̂3 or less), or 20000 mm̂3 or less (20 cm̂3 or less).

In an embodiment, a power tool can have a handle which has an average depressed grip volume which is in a range of 20000 mm̂3 (20 cm̂3) to 80000 mm̂3 (80 cm̂3), or 20000 mm̂3 (20 cm̂3) to 75000 mm̂3 (75 cm̂3), or 20000 mm̂3 (20 cm̂3) to 65000 mm̂3 (65 cm̂3), or 20000 mm̂3 (20 cm̂3) to 50000 mm̂3 (50 cm̂3), or 20000 mm̂3 (20 cm̂3) to 40000 mm̂3 (40 cm̂3), or 20000 mm̂3 (20 cm̂3) to 30000 mm̂3 (30 cm̂3), or 20000 mm̂3 (20 cm̂3) to 30000 mm̂3 (30 cm̂3).

In an embodiment, the average extended grip volume can be 200 cm̂3 or less such as 175 cm̂3, or 130 cm̂3, or 90 cm̂3, or 65 cm̂3. In an embodiment, the average depressed grip volume can be 125 cm̂3 or less, such as 115 cm̂3, or 60 cm̂3, or 55 cm̂3, or 50 cm̂3, or 40 cm̂3.

In an embodiment, the power tool handle can have a depressed grip width of 60 mm or less, 55 mm or less, or 40 mm or less, or 35 mm or less, or 28 mm or less, or 25 mm or less, or 15 mm or less. In an embodiment, the power tool handle can have a depressed grip width in a range of 15 mm to 60 mm, or 15 mm to 55 mm, or 15 mm to 50 mm, or 15 mm to 45 mm, or 15 mm to 30 mm, or 15 mm to 25 mm.

The power tool handle can have a ratio of handle height to depressed grip width in a range of from 3:2.5 to 20:1, or 3:2.5 to 10:1, or 3:2.5 to 5:1. The power tool handle can have a ratio of finger clearance to depressed grip width in a ratio of from 2:1 to 1:4, or 2:1 to 1:3, or 2:1 to 1:2, or 1:1.

In an embodiment, the power tool can have a handle width of 60 mm or less, such as 50 mm or less, or 40 mm or less, 35 mm or less, or 30 mm or less, or 28 mm or less, or 25 mm or less, or 20 mm or less when the switch assembly is in the depressed state.

In an embodiment, the power tool can have a handle width which has a value of 35 mm or less when the switch assembly is in the depressed state.

In an embodiment, a compact switch assembly for a power tool can have a trigger which can trigger a compact AC switch. The compact switch assembly can have at least a portion which is at least partially within a power tool handle. The compact switch assembly can have a depressed state; and the compact switch assembly can have a switch assembly width of 60 mm or less when the compact switch assembly is in its depressed state. In an embodiment the compact switch assembly for a power tool can have a trigger travel of 4 mm or more. In another embodiment, the compact switch assembly for a power tool can have a trigger travel distance of 15 mm or less, or 10 mm or less, or 8 mms or less, or 7 mm or less, or 6 mm or less, or 5 mm or less, or 3 mm or less. In yet another embodiment, the power tool can have a trigger travel of 3 mm or more and can have a value in a range of from 3 mm to 20 mm. The trigger travel distance can be in a range of from 3 mm to 30 mm, or 3 mm to 25 mm, or 3 mm to 20 mm, or 3 mm to 15 mm, or 3 mm to 10 mm, or 3 mm to 8 mm, or 3 mm to 7 mm, or 3 mm to 6 mm, or 3 mm to 5 mm, or 3 mm to 4 mm.

In an embodiment, the compact switch assembly can have a ratio of a switch assembly width when the compact switch assembly is in its depressed state to a trigger travel of 20:1 to 1.25:1. In another embodiment, the compact switch assembly can have a ratio of a switch assembly width when the compact switch assembly is in its depressed state to a trigger travel of 10:1 to 2:1.

Optionally, the compact switch assembly can have a grip depression height which is 15 mm or less, or 10 mm or less, or 5 mm or less, or 3 mm or less, or 2 mm or less. In an embodiment, the grip depression can have a grip depression height which is in a range of from 2 mm to 15 mm, or 2 mm to 10 mm, or 2 mm to 5 mm, or 5 mm to 15 mm.

The compact switch assembly for a power tool can have a first finger depression for gripping by an index finger and a second finger depression for gripping by a middle finger. Optionally, the trigger can have a flattened face. In another embodiment, the compact switch assembly can have a trigger which is hinged and has a trigger travel which is radial in its movement. In an embodiment, the trigger can have a compact actuator and/or switch.

In an embodiment, the power tool can be a jigsaw. The jigsaw can in one example embodiment have a handle which has a switch assembly which activates an electric motor which drives a jigsaw blade driving mechanism. The switch assembly can have a trigger and an AC compact variable switch which can have an extended state and a depressed state. In an embodiment, the switch assembly can have an extended state in which the trigger is in an extended configuration. In the extended configuration, the trigger can have an extended position along a trigger travel path. In an embodiment, when the switch assembly is in the extended state an extended grip width can be 55 mm or less. In another aspect, when the switch assembly is in the depressed state the trigger can have a depressed configuration. In the depressed configuration, the trigger can have a depressed position along the trigger travel path. In an embodiment, the switch assembly in a depressed state can have a depressed grip width which is 50 mm or less. In an embodiment, the jigsaw can have a switch assembly which when in the extended state can have an extended grip width is in a range of 55 mm to 35 mm, or 50 mm to 35 mm. When the switch assembly is in the depressed state, the switch assembly can have a depressed grip width which is in a range of 48 mm to 28 mm, or 45 mm to 28 mm, or 40 mm to 20 mm.

In an embodiment, the jigsaw can have a depressed grip perimeter of 300 mm or less, or 250 mm or less, or 200 mm or less, or 155 mm or less, or 140 mm or less, or 100 mm or less. In an embodiment, the jigsaw can have a trigger travel distance which is in a range of from 3 mm to 20 mm. In an embodiment, the jigsaw can have a handle height of 80 mm or less. In an embodiment, the jigsaw can have a grip depression which can have a grip depression height of 1 mm or greater. In an embodiment, the jigsaw can have a distance between a portion of the grip depression and a portion of the AC compact variable switch can be 35 mm or less, or 20 mm, or less, or 15 mm or less, or 10 mm or less, or 7 mm or less, or 5 mm or less, or 3 mm or less, or 2 mm or less. In an embodiment, the jigsaw can have a grip depression which can have a grip depression height in a range of 1 mm to 10 mm, or 1 mm to 20 mm, or 1 mm to 30 mm, or 5 mm to 20 mm, or 10 mm to 25 mm.

In an embodiment, a jigsaw can have a handle having a switch assembly which has an AC compact variable switch. The handle can have a depressed grip width of 60 mm or less. The handle can also have a trigger grip low point, as well as a finger clearance of 10 mm or greater measured between the trigger grip low point and a closest portion of a jigsaw body upper surface to the trigger grip low point.

In an embodiment, the jigsaw can have a power cord. In another embodiment, the jigsaw can be a cordless power tool. Optionally, the jigsaw can have a trigger lock movably received in the handle which can move between a locked position and an unlocked position. The power tool having the compact handle disclosed herein can be a corded or cordless power tool. The trigger lock can engage a trigger in the locked position to limit movement of the trigger along an axis of trigger travel.

In an embodiment, the jigsaw can have a switch assembly which when in an extended state can have an extended grip width which is 55 mm or less, and when the switch assembly is in a depressed state can have a depressed grip width is 35 mm or less, or 25 mm or less, or 20 mm or less, or 15 mm or less.

The jigsaw can have a handle height of 100 mm or less. In an embodiment, the jigsaw can have a finger clearance in a range of 15 mm to 50 mm.

In an embodiment, the jigsaw can have a distance between the a portion of the grip depression and a portion of the AC compact variable switch which is 20 mm or less, or 15 mm, or less, or 10 mm or less, or 5 mm or less, or 3 mm or less. The jigsaw can have a grip depression having a grip depression height in a range of 1 mm to 10 mm, such as 3 mm, or 4 mm, or 5 mm, or 7 mm, or 10 mm.

In an embodiment, a jigsaw can have a handle having a switch assembly which can have an AC compact variable switch. The handle can have a depressed grip width of 60 mm or less. The handle can also have a trigger grip low point, as well as a finger clearance of 10 mm or greater measured between the trigger grip low point and a closest portion of a jigsaw body upper surface to the trigger grip low point. The jigsaw can have a power cord, or can be cordless and receive power from a batter, pneumatic, solar or other power source.

In an embodiment, the jigsaw can have an electric motor housed in the jigsaw body; and a jigsaw blade driving mechanism driven by the electric motor. The switch assembly can have a trigger which triggers the AC compact variable speed switch. The switch assembly can have an extended state in which the trigger is in an extended position and a depressed state in which the trigger is depressed at least in part along a trigger travel distance. The handle can have an extended handle width value of 55 mm or less when the trigger is in the extended position. The handle can have a depressed grip width of 50 mm or less when the trigger is depressed. In an embodiment, the jigsaw can have a handle which has an extended handle width value of 50 mm or less when the trigger is in the extended position. In an embodiment, the trigger can be depressed along a trigger travel distance between the extended state and the depressed state which is at least 4 mm. In an embodiment, the handle can have a depressed grip perimeter of 155 mm or less.

Optionally, the jigsaw can have a trigger lock movably received in the handle that moves between a locked position and an unlocked position wherein the trigger lock engages the trigger in the locked position to limit movement of the trigger along the axis of trigger travel.

### BRIEF DESCRIPTION OF THE DRAWINGS

The present invention in its several aspects and embodiments solves the problems discussed above and significantly advances the technology of fastening tools. The present invention can become more fully understood from the detailed description and the accompanying drawings, wherein:

FIG. 1 is a perspective view of a jigsaw having a compact handle;

FIG. 2 is a perspective side view of the jigsaw having a compact handle;

FIG. 3 is a side view of the jigsaw having a compact handle;

FIG. 4 is a view of a grip depression;

FIG. 5 is an exploded view of the jigsaw having a compact handle;

FIG. 6 is an illustration of a hand;

FIG. 7 shows the hand gripping a compact handle;

FIG. 8 shows an upper grip axis and a lower grip axis of a grip assembly;

FIG. 9 is a sectional view of the compact handle;

FIG. 10 is a detail sectional view an exemplary compact AC switch of the compact handle;

FIG. 11 is a side view of the compact handle showing a trigger in an extended state;

FIG. 12 is a sectional side view of the compact handle showing the trigger in an extended state;

FIG. 13 is a sectional side view of the compact handle showing the trigger being depressed;

FIG. 14 is a sectional side view of the compact handle showing the trigger in a depressed state;

FIG. 15 is a sectional side view of the compact handle showing an average upper trigger grip volume and an average lower trigger grip volume;

FIG. 16 is a sectional side view of the compact handle showing an average trigger grip volume;

FIG. 17 is a perspective view of a trigger assembly in an extended state;

FIG. 18 is a perspective view of a trigger assembly in a depressed state;

FIG. 19 is a sectional view of the compact handle taken across a lower grip plane and showing the lower extended trigger circumference;

FIG. 20 is a sectional view of the compact handle taken across a lower grip plane and showing a lower extended trigger perimeter;

FIG. 21 is a sectional side view of the compact handle showing a trigger having a compact wiring configuration;

FIG. 22A is a sectional side view of the compact handle having a housing handle portion configured closely around a compact AC switch in an extended state;

FIG. 22B is a sectional side view of the compact handle having a housing handle portion configured closely around a compact AC switch in a depressed state;

FIG. 23A is a sectional view of the compact handle having a pocketed AC switch and a thin handle;

FIG. 23B shows a compact handle having a compression trigger;

FIG. 23C shows a compact handle having a pull lever trigger;

FIG. 24A shows a compact handle having a compact AC switch.

FIG. 24B shows a compact handle having a trigger having an index finger notch and a middle finger notch;

FIG. 24C shows a compact handle having a trigger with a flattened face;

FIG. 24D shows a compact handle having a low profile trigger; and

FIG. 25 is a side elevation view of an exemplary compact AC switch and illustrates a printed circuit board.

Herein, like reference numbers in one figure refer to like reference numbers in another figure.

### DETAILED DESCRIPTION OF THE INVENTION

This disclosure relates to a compact handle for a power tool. The compact handle can be used in many different professional and consumer power tools such as but not limited to: a jigsaw, a reciprocating saw, a drill, a screwdriver, a hammer drill, an SDS hammer drill, a corded drill, a cordless drill, a driver, a nailer, a nail gun, a riveter, a stapler, a staple gun, an impactor, an impact driver, an impact wrench, a weed wacker, a chainsaw, a trimmer, a hedge trimmer, a tree trimmer, a pole saw, an edger, a sander, a circular saw, a miter saw, a chop saw, multitools, a modular power tool, a grinder, a rotational tool, a rotary tool, an in-line circular saw, an in-line rotating tool, an in-line multisaw, a pressure washer, a paint gun, a pole tool, an oscillating tool, a tile saw, a belt sander, a plunge cutting saw, an inflator, a buffer, a router, a light, a flashlight, or any other tool having a handle.

The compact handle achieves a size which provides an operator a comfortable, solid and safe grip while operating the power tool. In an embodiment, the power tool can have an AC compact variable switch which controls the speed of a motor driving the power tool. In addition to providing an operator an exceptional grip, the compact handle also achieves a handle height above a portion of a body of the power tool which accommodates a safe and comfortable finger clearance, while optionally maintaining a low-profile of a total height dimension of the power tool.

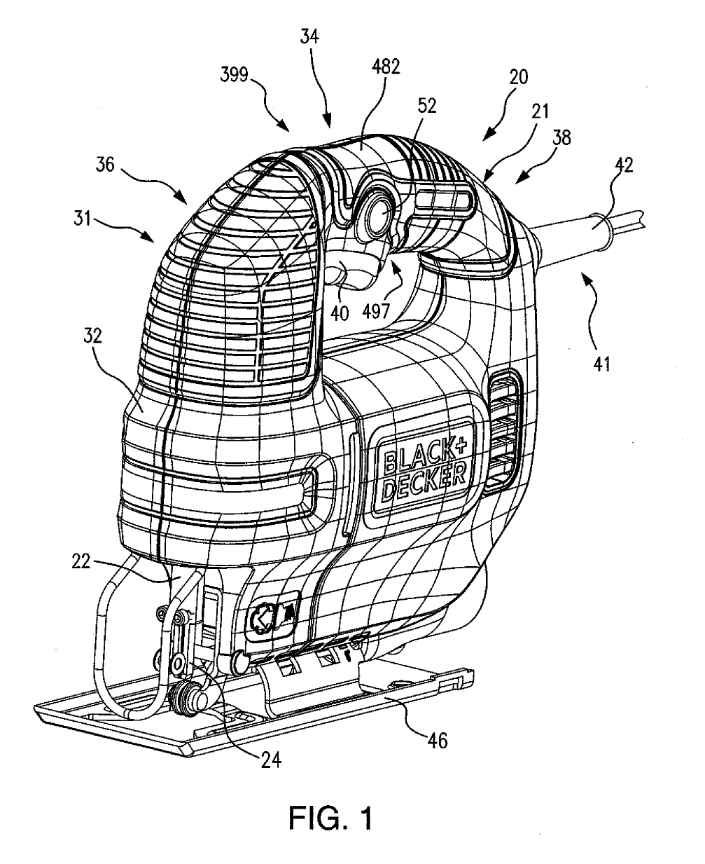

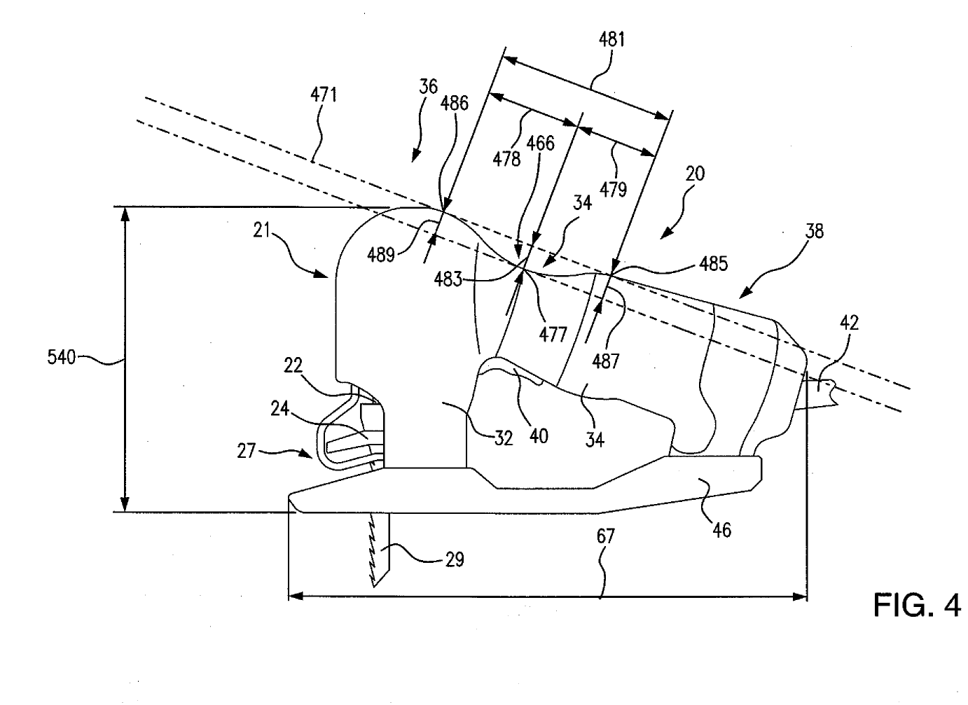

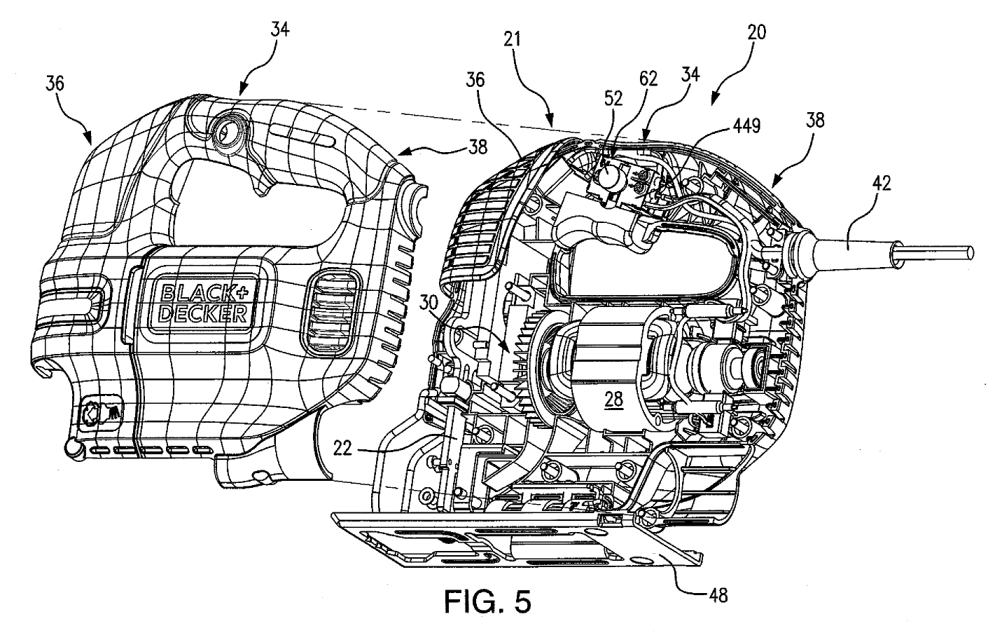

FIG. 1 is a perspective view of a jigsaw having a compact handle. FIG. 1 shows a power tool 20 which can be a handheld power tool 21 having a driven shaft 22 which can drive a saw blade 29 as the tool piece 27 (FIG. 4). The power tool 20 can have a compact handle 34. In an embodiment, the power tool 20 that has a compact handle 34 can be the handheld power tool 21 or can be the power tool 20 which is not hand held. The driven shaft 22 can have an end 24 for receiving a tool piece 27, such as a saw blade 29 (FIG. 4). The type of power tool 20 which has a compact handle 34 is not limited by this application and this disclosure is to be broadly construed. In the example embodiment of FIG. 1, the handheld power tool 20 is a jigsaw 31. In another embodiment, the handheld power tool 21 can be a drill in which the end 24 of the driven shaft 22 can receive a drill bit or screw driver bit as the tool piece 27. In another embodiment the handheld power tool 21 can be a sander in which the end 24 of the driven shaft 22 can receive a sanding pad which can be a segment of sandpaper, an abrasive pad, or an abrasive belt. In an embodiment, the hand held power tool 20 can have an electric motor 28 (FIG. 5).

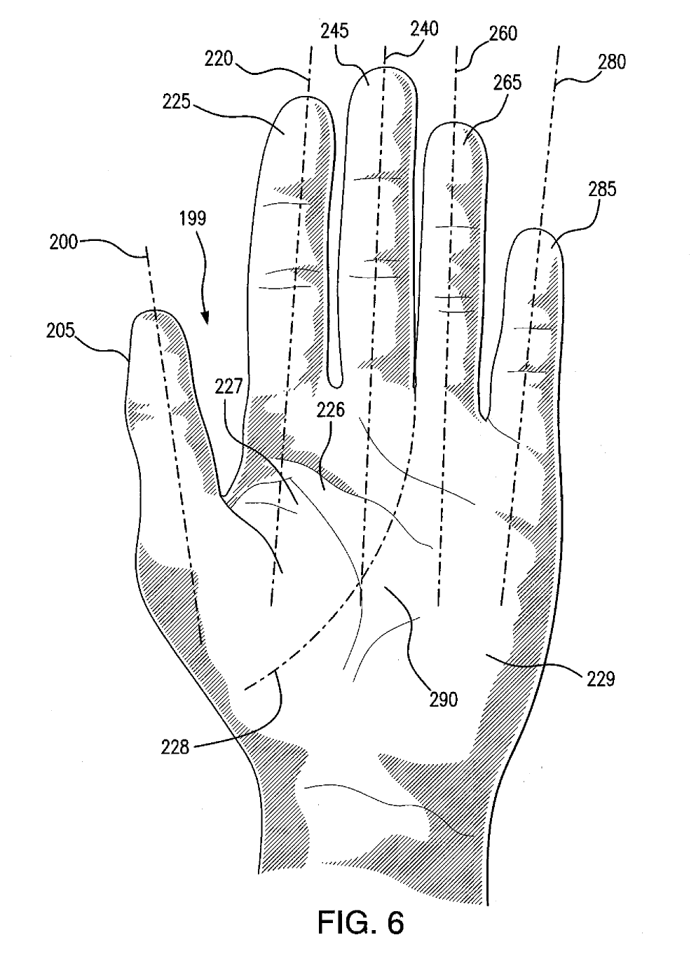

The power tool 20 can have a housing 32 that contains at least a part of the electric motor 28. The housing 32 can take a variety of forms and can include one or more components. For example, the housing 32 can include two half shells as shown in FIG. 5. In FIG. 1, the housing 32 can include a compact handle 34, which can take several forms. For example, the compact handle 34 can be a separate component that is attached to the housing 32, an integral piece formed with the housing 32, or reversibly attachable. In an embodiment, the compact handle 34 can provide a grip portion 399 where a user can grip the handheld power tool 21 with a hand 199 (FIG. 6). The housing 32 can additionally include a head portion 36 that contains at least a portion of the driven shaft 22 and an aft portion 38 that is spaced from the head portion 36. In an embodiment the compact handle 34 can span a distance between a portion of the head portion 36 and a portion of the aft portion 38. In the example embodiment of FIG. 1, the electric motor 28 can be housed in the aft portion 38 of the housing 32 (FIG. 5). The FIG. 1 example of a jigsaw 31 illustrates an embodiment having a shoe 46 which can optionally be fixed to the housing 32 or pivotally connected to the housing 32. The shoe 46 generally has a bottom surface 48 (FIG. 5) facing away from the housing 32 for abutting a work piece

In an embodiment, the compact handle 34 of the handheld power tool 21 can have a grip portion 399 about which a hand 199 can grip the compact handle 34. The design of the grip portion 399 (also as a “handle grip 399” or “grip 399”) can vary broadly. Optionally, the grip portion 399 can have a grip depression 482. The handle can also have a switch assembly 497. The embodiment of FIG. 1 shows the switch assembly 497 having a trigger 40 and an optionally a trigger lock 52.

In an embodiment, the handheld power tool 21 can receive power through means such as a power cord 41, which can optionally be an AC power cord 42, or a DC power cord. In another embodiment, the handheld power tool 21 can be cordless and can receive power from one or more batteries. In another embodiment, the handheld power tool 21, can be pneumatic, gas powered, solar powered, or powered by another source. This disclosure is not limiting as to the source of power which can be used by the handheld power tool 21.

In an embodiment, the power tool 20 and/or compact handle 34 can further have a wireless communication device which can transmit data regarding the power tool. There is no limit as to the data which can be transmitted from the power tool by the wireless communication device, such as a Bluetooth device and/or transmitter. The types of data can include, but are not limited to: tracking vibration of the power tool; measuring speeds under a load and no-load conditions; measuring current levels under load and no-load conditions, measuring temperature of the power tool; battery status; drop impact levels; life of the power tool and/or the number of switch actuations. Such data can be transmitted from any type of power tool, such as a jigsaw.

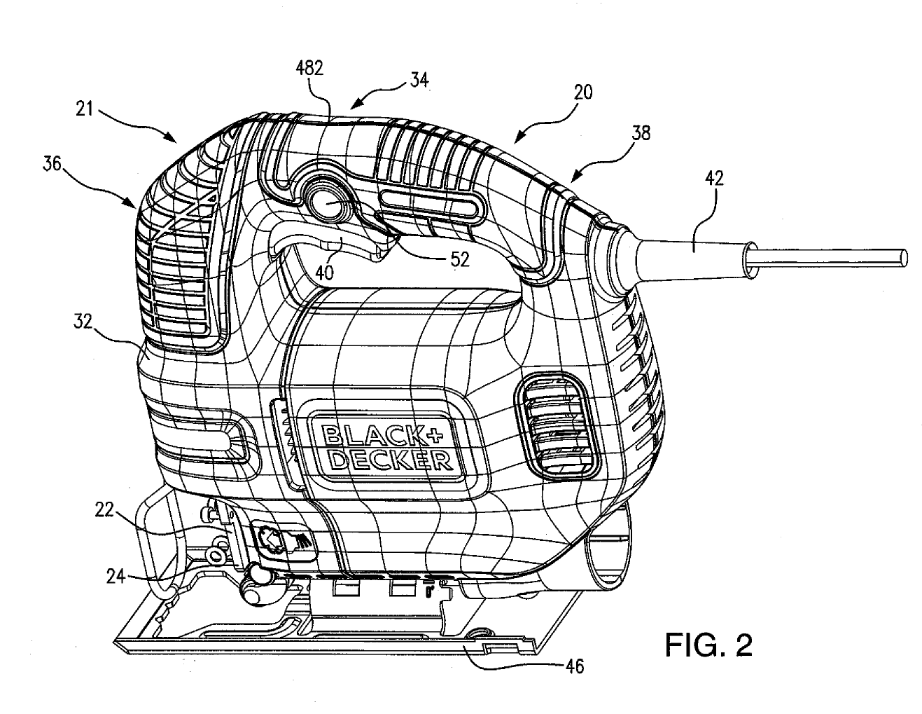

FIG. 2 is a perspective side view of the jigsaw having a compact handle. In an embodiment, the handheld power tool 21 can have the trigger 40 which can be slidingly received at least in part in the housing 32 such that the trigger 40 can extend at least partially through a trigger opening of the compact handle 34. In an embodiment, the trigger 40 can slide with respect to the compact handle 34 for movement between an extended position, a depressed position, and a plurality of trigger positions therebetween. The position of the trigger 40 can control the operation of the electric motor 28. In an embodiment, the trigger 40 can control an AC compact variable speed switch 449 which can control the operation of the electric motor 28. The electric motor 28 can be set and/or maintained in an undriven and/or unpowered state in which the motor does not act to drive the handheld power tool 21 when the trigger 40 is in the extended position. Movement of the trigger 40 from the extended position toward the depressed position can place the electric motor 28 in a driven and/or motor powered state in which the motor turns to drive the handheld power tool 21. Further, each trigger position of the plurality of trigger positions can correspond to a motor speed. The motor speed can be fixed, variable or set to increase or decrease as a function of trigger position. The motor speed can also be staggered or staged to increase or decrease as a function of trigger position. Additionally, in an embodiment, the motor speed can be limited, e.g. to not increase and/or to stay steady, after the trigger 40 has moved past a predetermined trigger position which is located between the extended position and the depressed position. For example, the motor speed can be limited from increasing after the trigger 40 has moved past a predetermined trigger position, for example optionally corresponding to approximately 70 percent of the distance between the extended position and the depressed position of the trigger 40.

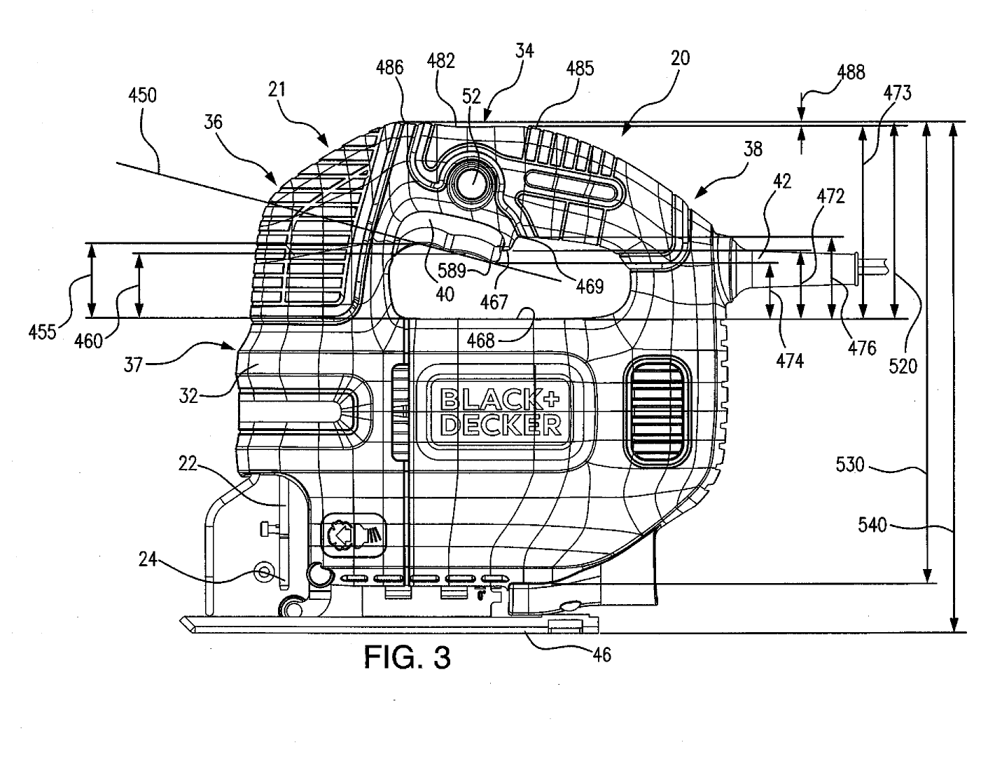

FIG. 3 is a side view of the jigsaw having a compact handle. FIG. 3 is a schematic side view of the jigsaw 31 having a compact handle and showing a cutting blade. FIG. 3 shows various dimension of the jigsaw 31.

Numeric values and ranges herein, unless otherwise stated, are intended to have associated with them a tolerance and to account for variances of design and manufacturing. Thus, a number can include values “about” that number. For example, a value X is also intended to be understood as “about X”. Likewise, a range of Y to Z, is also intended to be understood as within a range of from “about Y to about Z”. Additionally, example numbers disclosed within ranges are intended also to disclose sub-ranges within a broader range which have an example number as an endpoint. A disclosure of any two example numbers which are within a broader range is also intended herein to disclose a range between such example numbers. Unless otherwise stated, significant digits disclosed for a number are not intended to make the number an exact limiting value. Variance and tolerance is inherent in mechanical design and the numbers disclosed herein are intended to be construed to allow for such factors (in non-limiting e.g., ±10 percent of a given value). Likewise, the claims are to be broadly construed in their recitations of numbers and ranges.

The compact handle 34 can have a handle height 520 in a range of from 40 mm to 100 mm, or from 50 mm to 90 mm, or 50 mm to 85 mm, or 40 mm to 75 mm; having a value such as for example: 50 mm, or 60 mm, or 65 mm, or 75 mm, or 85 mm.

The compact handle 34 can have a finger clearance 472 in a range of from 15 mm to 50 mm, or 20 mm to 40 mm, or 20 mm to 30 mm, or 15 mm to 25 mm; having a value such as for example: 18 mm, or 25 mm, or 27 mm, or 30 mm, or 35 mm or 40 mm. In different embodiments, finger clearance can be measured from difference locations on the compact handle 34 and/or the power tool 20. It is intended that finger clearance be broadly construed and that the term include any width provided to accommodate the placement and insertion of once or more fingers when forming a grip upon a power tool 21.

The compact handle 34 can have a low point height 473 in a range of from 15 mm to 80 mm, or 50 mm to 80 mm, or 35 mm to 65 mm, or 40 mm to 60 mm, or 15 mm to 75 mm, or 20 mm to 50 mm; or 20 mm to 40 mm, or 15 mm to 30 mm; having a value such as for example: 18 mm, or 25 mm, or 26 mm, or 27 mm, or 30 mm, or 35 mm, or 40 mm, or 50 mm.

The compact handle 34 can have a jigsaw height 540 in a range of from 100 mm to 300 mm, or 100 mm to 250 mm, or 100 mm to 200 mm, or 100 mm to 175 mm, or 100 mm to 150 mm, or 100 mm to 125 mm; having a value such as for example: 115 mm, 125 mm, 130 mm, 150 mm, or 175 mm, or 198 mm, or 200 mm, or 250 mm.

The compact handle 34 can have a housing height 530 in a range of from 50 mm to 275 mm, or 50 mm to 250 mm, or 50 mm to 200 mm, or 50 mm to 150 mm, or 50 mm to 100 mm; having a value such as for example: 100 mm, or 125 mm, or 150 mm, or 175 mm.

The compact handle 34 can have a handle offset 488 in a range of from 1 mm to 15 mm, or 1 mm to 10 mm, or 1 mm to 5 mm, or 1 mm to 3 mm; having a value such as for example: 2 mm, or 3 mm, or 4 mm, or 5 mm, or 6 mm, or 10 mm. In an embodiment, the handle offset 488 can be the difference between a grip depression high point 486 and a grip depression offset point 485.

The compact handle 34 can have a trigger low point 589. The compact handle 34 can have a trigger low point clearance 474 in a range of from 15 mm to 50 mm, or 15 mm to 40 mm, or 15 mm to 35 mm, or 15 mm to 30 mm, or 15 mm to 25 mm, or 15 mm to 20 mm; having a value such as for example: 18 mm, or 25 mm, or 27 mm, or 30 mm, or 35 mm or 40 mm.

The compact handle 34 can have a trigger seat low point 467 and a trigger seat high point 469. The compact handle 34 can have a finger clearance 472 in a range of from 15 mm to 50 mm, or 15 mm to 40 mm, or 15 mm to 35 mm, or 15 mm to 30 mm, or 15 mm to 25 mm, or 15 mm to 20 mm; having a value such as for example: 18 mm, or 25 mm, or 27 mm, or 30 mm, or 35 mm or 40 mm.

The compact handle 34 can have a trigger seat high point 469. The compact handle 34 can have a trigger seat high point clearance 476 in a range of from 15 mm to 50 mm, or 15 mm to 40 mm, or 15 mm to 35 mm, or 15 mm to 30 mm, or 15 mm to 25 mm, or 15 mm to 20 mm; having a value such as for example: 18 mm, or 25 mm, or 27 mm, or 30 mm, or 32 mm, or 35 mm, or 40 mm.

The compact handle 34 can have an index finger clearance 455 in a range of from 10 mm to 40 mm, or 10 mm to 35 mm, or 10 mm to 30 mm or 10 mm to 25 mm, or 10 mm to 25 mm, or 10 mm to 20 mm, or 10 mm to 15 mm; having a value such as for example: such as 15 mm, or 20 mm, or 29 mm, or 30 mm, or 35 mm.

The compact handle 34 can have a middle finger clearance 460 in a range of from 10 mm to 40 mm, or 10 mm to 35 mm, or 10 mm to 30 mm or 10 mm to 25 mm, or 10 mm to 25 mm, or 10 mm to 20 mm, or 10 mm to 15 mm; having a value such as for example: such as 15 mm, or 20 mm, or 25, or 26 mm, or 30 mm, or 35 mm.

The compact handle 34 can have a trigger face plane 450. The compact handle 34 can also have a jigsaw body 37 having a jigsaw body upper surface 468.

In an embodiment, the compact handle 34 can have a ratio of handle height to depressed grip width in a range of from 1.25:1 to 20:1, or 1.5:1 to 3:1, or 1.5:1 to 3.5:1, or 1.5:1 to 2.5:1, or greater; having a value such as for example: 4:1, or 5:3; or 5:2, or 3:2, or 5:1; or 20:11, or 20:7, or 10:1.

In an embodiment, the compact handle 34 can have a ratio of finger clearance to depressed grip width in a ratio of 20:1 or less. For example the ratio of finger clearance to depressed grip can be in a range of from 10:1 to 1:1, or 5:1 to 1:1, or 3:1 to 1:1, or 2:1 to 1:1; having a value such as for example: 5:1, or 4:1, or 2.5:1, or 2:1, or 1.3:1, or 1.25:1, or 1.2:1, or 1.1:1. The ratio of finger clearance to depressed grip width may also be in a range of from 1.5:1 to 0.5:1 or 1:1 to 0.5:1.

In an embodiment, the compact handle 34 can have a ratio of finger clearance to depressed grip width in a ratio of 0.5:5 or greater. The ratio of finger clearance to depressed grip width may also be 0.4:1 or greater, 0.5:1 or greater, 0.6:1 or greater or 0.65:1 or greater. For example the ratio of finger clearance to depressed grip can be in a range of 0.5:5 to 0.5:20, or 0.5:5 to 0.5:15, or 0.5:5 to 0.5:10; having a value such as for example: 1:1.1, or 1:1.2, or 1:1.25, or 1:1.3, or 1:2, or 1:3, or 1:4, or 1:5, or 1:10 or 1:15, or 1:20.

FIG. 4 is a view showing dimensions of a grip depression. In the embodiment of FIG. 4, the compact handle 34 has a grip depression 466 having a grip depression height 483. The grip depression height can be measured perpendicular to a grip depression upper axis 471 to a grip depression low point 477. In an embodiment, the grip depression upper axis 471 can pass through a grip depression high point 486 and a grip depression offset point 485.

In an embodiment, a grip depression lower axis 457 can pass through the grip depression low point 477 and be parallel to the grip depression upper axis 471. The grip depression 466 can have a grip depression high point height 489 and a grip depression low point height 483.

The grip depression 466 can have a grip depression width 481. The grip depression width can have a grip depression high point width 478 and a grip depression high point width 479. FIG. 4 also shows the jigsaw length 67.

FIG. 5 is an exploded view of the jigsaw having a compact handle. The electric motor 28 can have a powered state and/or rotating state and an unpowered state and/or not rotating state. In an embodiment, the electric motor 28 receives no electricity when the electric motor 28 is in the unpowered state and the electric motor 28 does not move the driven shaft 22 in the unpowered state. Conversely, in an embodiment, the electric motor 28 receives electricity when the electric motor 28 is in the powered state and the electric motor 28 moves the driven shaft 22 in the powered state. The compact handle 34 can have a trigger switch 62.

The electric motor 28 can turn at a plurality of motor speeds in the powered state and optionally can have two directions of rotation based upon the polarity of the electricity supplied to the electric motor 28. The plurality of motor speeds can be measured by rotational speed such as by revolutions per minute (rpm). Alternatively, the electric motor 28 can provide only a single operational speed in the powered state. As such, the handheld power tool 21 can optionally have variable speeds, as well as and forward and reverse directions of rotation. Regardless, the electric motor 28 is coupled to the driven shaft 22 for driving the driven shaft 22. The electric motor 28 can be coupled to the driven shaft 22 by a drive mechanism 30 (FIG. 5) such as in non-limiting example, by a transmission or an eccentric drive mechanism. Accordingly, the driven shaft 22 can rotate, reciprocate, and/or follow an orbital movement in response to being driven by the electric motor 28.

The handheld power tool 21 can have an AC power cord 42 extending through the housing 32 which can supply electricity to the electric motor 28 and/or the handheld power tool 21. More particularly, at least one motor lead 44 can be disposed within the housing 32 that is electrically connected to AC power cord 42 and the electric motor 28. The at least one motor lead 44 can take many forms and can provide a controlled level of electricity to the electric motor 28. By way of example, and without limitation, the at least one motor lead 44 can be a wire or a number of wires.

FIG. 6 is an illustration of a hand 199 of a human. The hand 199 shown in FIG. 6 has a thumb 205 having a thumb centerline 200. The hand 199 has an index finger 225 having an index finger centerline 220. The hand 199 has a middle finger 245 having a middle finger centerline 240. The hand 199 has a ring finger 265 having a ring finger centerline 260. The hand 199 has a little finger 285 having a little finger centerline 280.

The hand 199 has a palm 290 which has an upper palm 227 and a lower palm 229. The upper palm 227 and the lower palm 229 can be differentiated by a palm line 228. An area of the palm which comprises a portion of the thumb 205, a portion of the index finger 225, a portion of the middle finger 245 and a portion of the upper palm 227 is herein referred to as the gripping saddle 226 of the hand.

In an embodiment, the gripping saddle 226 of the hand can at least in part contact with the grip depression 466 when the hand 199 grips the compact handle 34.

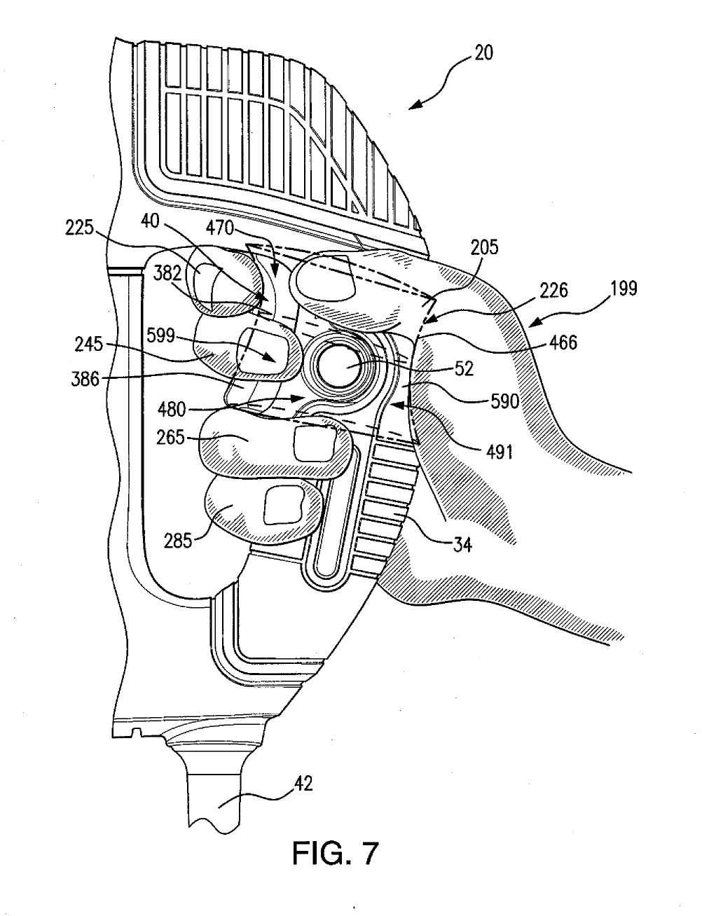

FIG. 7 shows the hand 199 gripping a compact handle 34. The hand 199 is shown gripping the compact handle 34 which has a grip assembly 599 having a handle grip 590, a trigger 40 and optionally a trigger lock 52. The hand 199 is shown having index finger 225 gripping an index finger notch 382 of trigger 40. The middle finger 245 is shown gripping the middle finger notch 386. The thumb 205 is shown gripping the handle grip 590 and the palm 290 is also shown gripping the handle grip 590. The grip depression 466 is shown by invisible line in FIG. 7. The gripping saddle 226 of hand 199 is shown fitting with the grip depression 466 of the handle grip 590. The gripping saddle 226, index finger 225 and middle finger 245 are shown gripping the grip assembly 590.

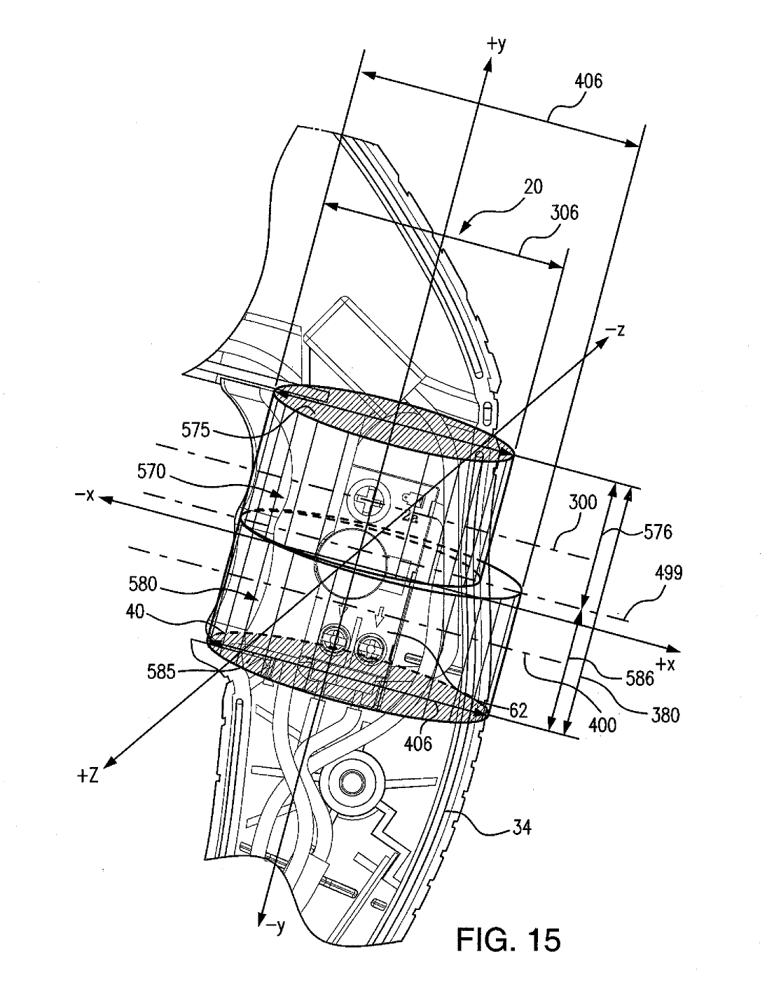

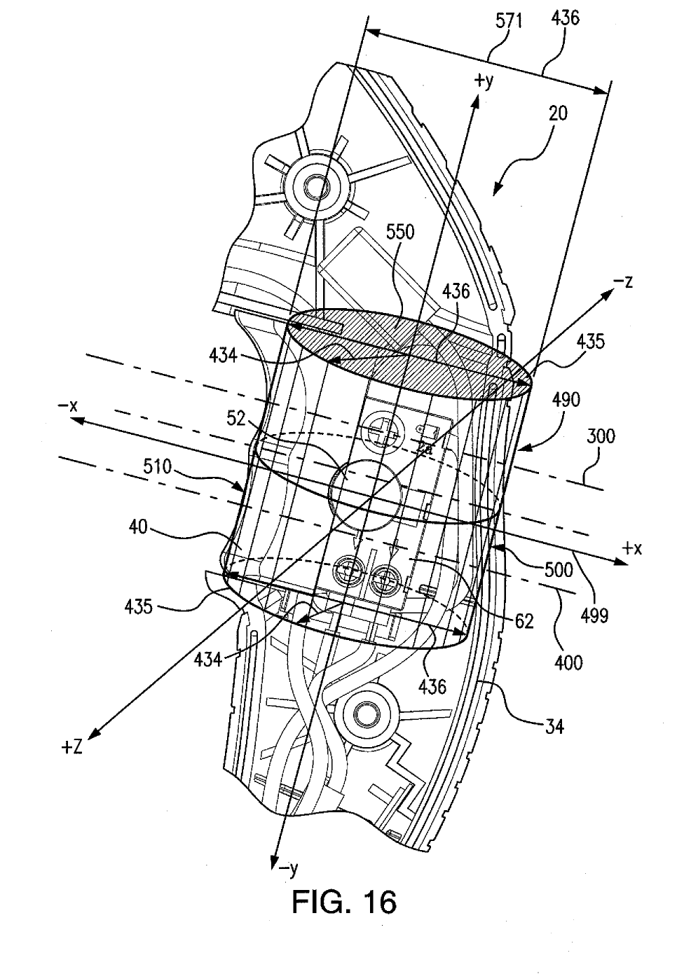

The grip assembly 599 has a grip volume 491. In an embodiment, the grip volume 491 is the volume of portions of the grip 590, the trigger 40 and the compact handle 34 (see also FIGS. 15 and 16). The integral of the volumes contributed by these portions is the grip volume. In an embodiment, the grip volume is also the volume of the grip assembly 590 contained within the gripping hand and/or a portion of the gripping hand. For example, the grip volume 491 is shown by invisible line and contains an upper grip volume 470 and a lower grip volume 480.

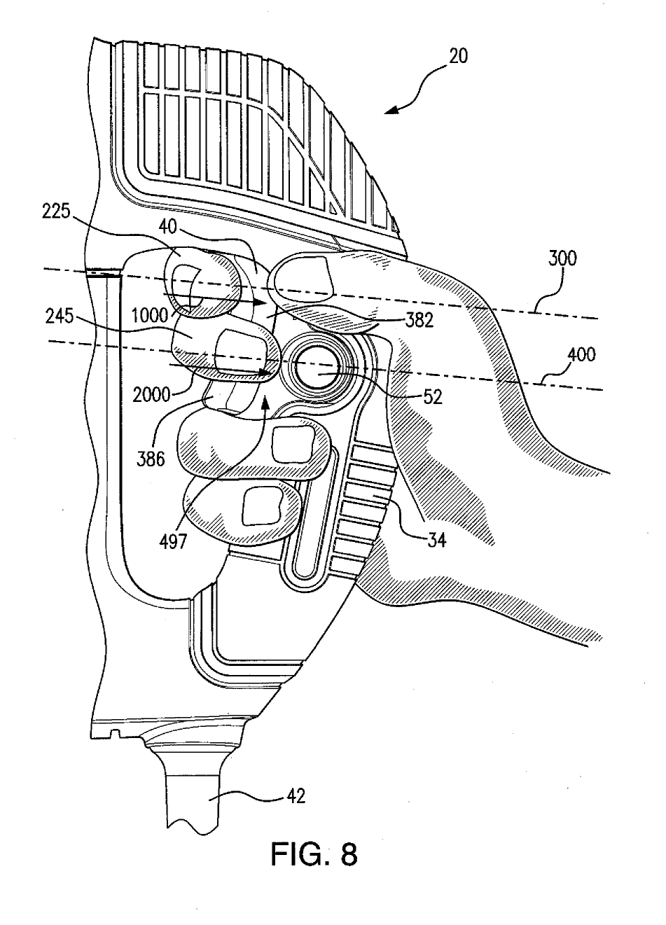

FIG. 8 shows an upper grip axis 300 and a lower grip axis 400 of a grip assembly 599 which can comprise a switch assembly 497. FIG. 8 shows the hand 199 having the index finger 225 gripping the index finger notch 382 of trigger 40. The middle finger 245 is shown gripping the middle finger notch 386.

The index finger 225 is shown gripping the trigger 40 and pulling in the direction of arrow 1000 to depress the switch assembly 497. In this example, the direction of pull of the index finger 225 can be along (and/or collinear and/or parallel to) an upper grip axis 300. The middle finger 245 is shown gripping the trigger 40 in the direction of arrow 2000 to depress the switch assembly 497. In this example, the direction of pull of the middle finger 245 can be along (and/or collinear and/or parallel to) a lower grip axis 400.

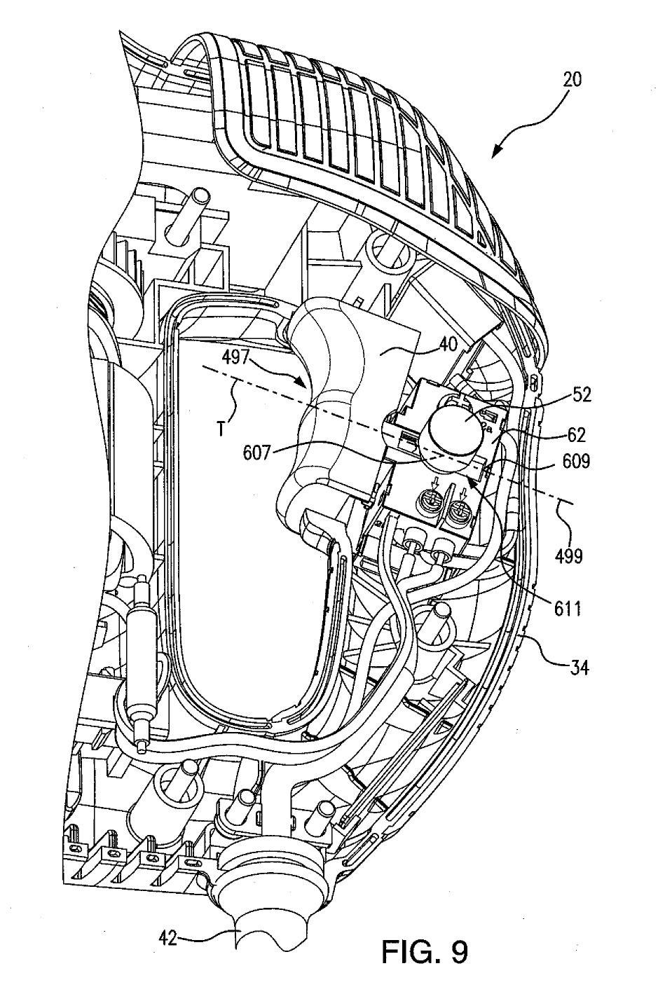

FIG. 9 is a sectional view of the compact handle 40. FIG. 9 shows a perspective of the switch assembly 497 which has a trigger 40 which can move along (and/or collinear and/or parallel to) a trigger travel axis 499 (also as axis “T”) to switch a trigger switch 62 of the switch assembly 497. In an embodiment, a trigger travel path 611 can guide the movement of the trigger 40 travel from a start point 607 to an end point 609.

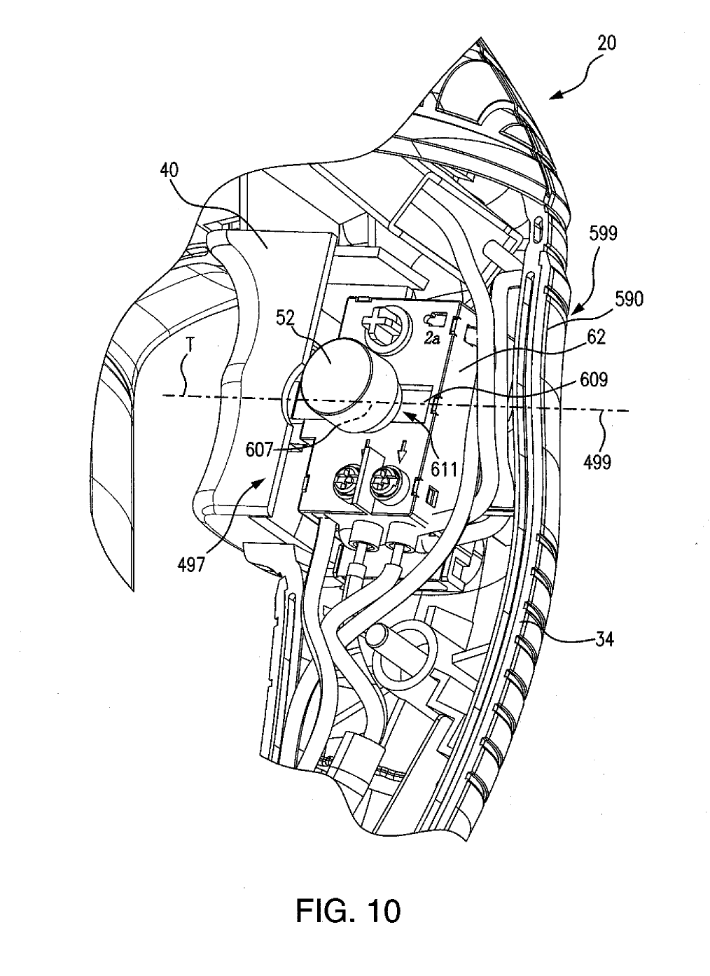

FIG. 10 is a detail sectional view an exemplary compact AC switch of the compact handle. In an embodiment, the compact AC switch can be an AC compact variable switch. FIG. 10 is a closer view of an example embodiment of the trigger switch 62 of switch assembly 497, which can be an AC compact variable switch, and trigger 40. In this embodiment, the trigger 40 can travel along the trigger travel path 611 from the start point 607 to the end point 609. In this embodiment, the direction of travel is shown along a trigger travel axis 499.

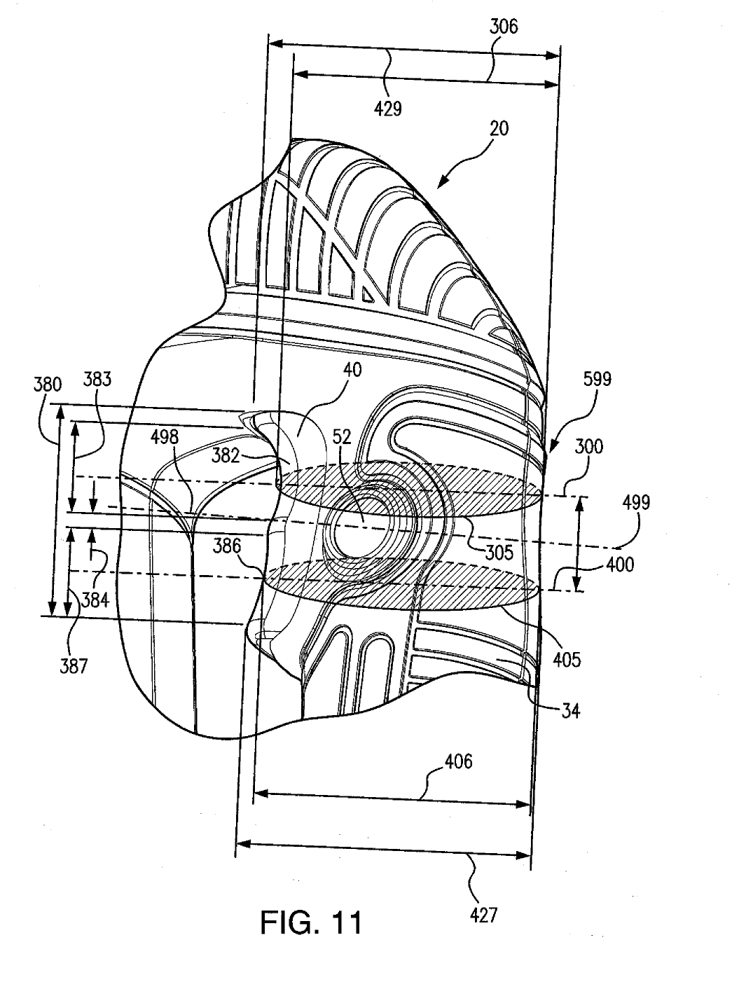

FIG. 11 is a side view of the compact handle 34 showing the trigger 40 which is in an extended state. FIG. 11 shows a handle having a switch assembly 497 in an extended state. The switch assembly 497 has both an extended stated and a depressed state. In an embodiment, the switch transitions from its extended state to its depressed state as a user depresses the trigger 40 along its trigger travel path which, in an example is along a trigger travel axis 499. There is no limitation as to the geometry of the trigger travel path which, for example, can be but is not limited to a straight path, a curved path, a radial path, a sinusoidal path, a mixed shaped path or other path.

In an embodiment a grip assembly 599 can have, but is not limited to, a handle grip 590 (also herein as a “grip 590”) and the switch assembly 497 and its components such as the trigger 40 and the trigger switch 62.

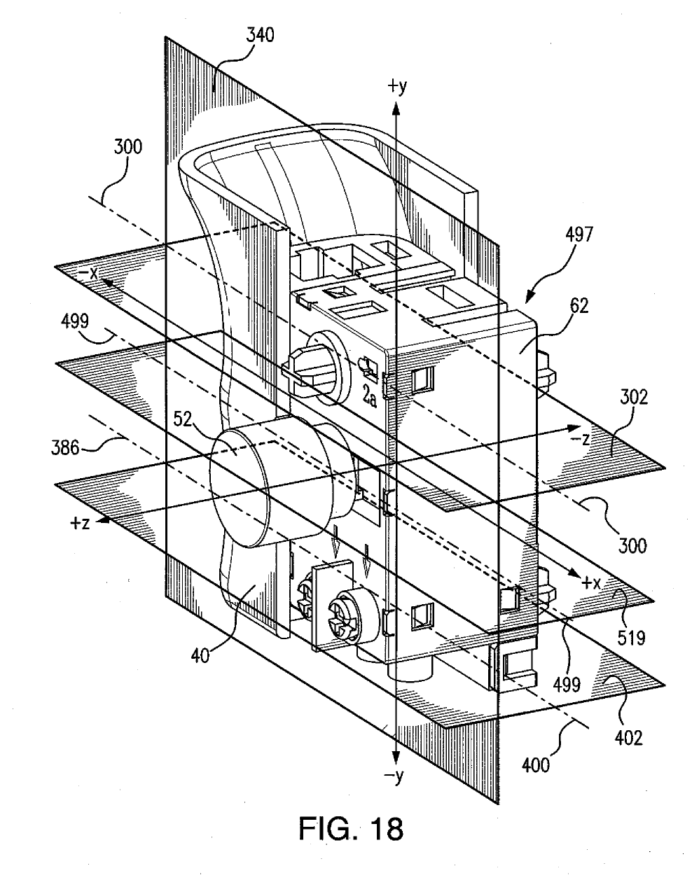

FIG. 11 shows the grip assembly 599 which has the trigger 40 having an index finger notch 382 and a middle finger notch 386. The index finger notch 382 is configured about upper grip axis 300. An upper extended grip circumference 305 is shown transecting the compact handle 34 and coplanar with a first grip plane 302 (FIG. 18). The first grip plane 302 can be perpendicular to handle plane 340 (FIG. 18).

The grip assembly 599 can have a grip axis 498 along which the moment of a hand gripping is directed. In the example embodiment shown in FIG. 11, the grip axis 498 can be collinear and/or parallel with the trigger travel axis 499. In other embodiments, the grip axis 498 and trigger travel axis 499 are not collinear.

The middle finger notch 386 is configured about a lower grip axis 400. A lower extended grip circumference 407 is shown transecting the compact handle 34 and coplanar with a lower grip plane 402 (FIG. 18). The lower grip plane 402 can be perpendicular to handle plane 340 (FIG. 18).

In the example of FIG. 11, the trigger 40 can have trigger length 380, well as index finger notch length 383, a middle finger notch length 387 and a trigger transition portion 384 over which the shape of the trigger 40 face transitions between the index finger notch 382 and the middle finger notch 386. In an embodiment, the trigger length 380 can have a value of from 10 mm to 250 mm, or 10 mm to 200 mm, or 10 mm to 150 mm, or 10 mm to 80, or 10 mm to 60 mm, or 10 mm to 50 mm, or 10 mm to 40 mm, or 10 mm to 30 mm, or 10 mm to 20 mm; having a value such as for example: 20 mm, or 25 mm, or 30 mm, or 38 mm, or 40 mm, or 50 mm, or 60 mm, or 80 mm, or 100 mm, or 125 mm, or 150 mm.

FIG. 11 also shows an upper extended grip width 306 and a lower extended grip width 406. In an embodiment, the upper extended grip width 306 which can have a value of from 15 mm to 60 mm, or 15 mm to 50 mm, or 15 mm to 40 mm, or 15 mm to 30 mm, or 15 mm to 25 mm, or 15 mm to 20 mm; having a value such as for example: 30 mm, or 32 mm, or 34 mm, or 35 mm, or 36 mm, or 38 mm, or 40 mm, or 42 mm, or 45 mm, or 48 mm, or 50 mm, or 53 mm, or 55 mm, 58 mm. In an embodiment, the lower extended grip width 406 can have a value of from 15 mm to 60 mm, or 15 mm to 50 mm, or 15 mm to 40 mm, or 15 mm to 30 mm, or 15 mm to 25 mm, or 15 mm to 20 mm; having a value such as for example: 30 mm, or 32 mm, or 34 mm, or 35 mm, or 36 mm, or 38 mm, or 40 mm, or 42 mm, or 45 mm, or 48 mm, or 50 mm, or 53 mm, or 55 mm, 58 mm.

Lower grip width 427 and upper grip width 429 are also shown in FIG. 11. The lower extended grip circumference 405 is also shown.

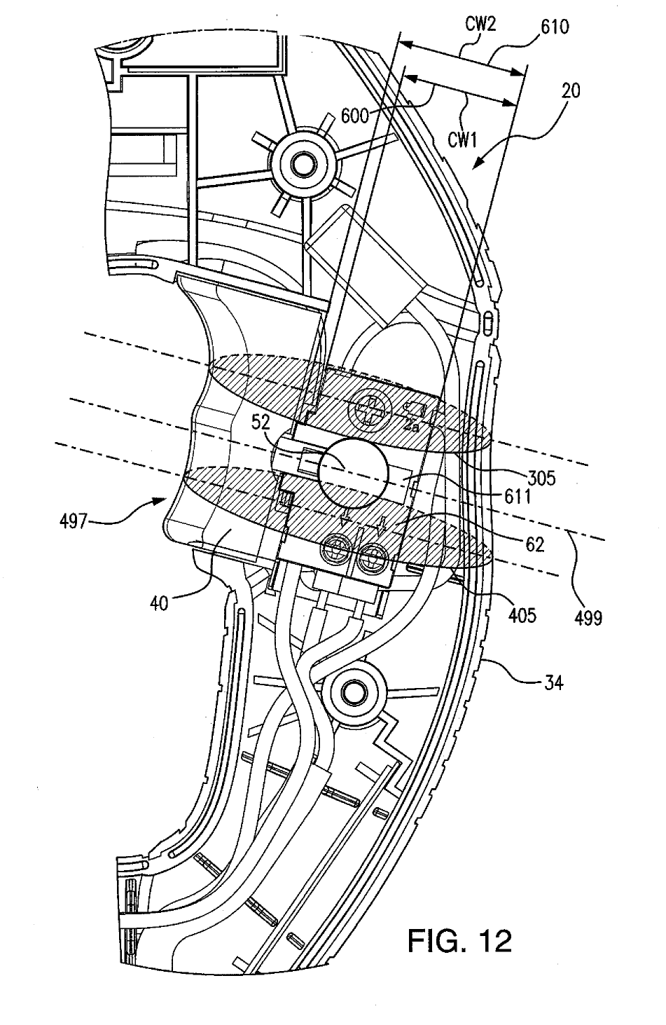

FIG. 12 is a sectional side view of the compact handle 34 showing a trigger 40 which is in an extended state. FIG. 12 shows an example embodiment of a trigger switch 62, which can be an AC switch, such as an AC compact variable switch, which can optionally have a first switch cover width 600 (also as “CW1”) and a second switch cover width 610 (also as “CW2”). In the FIG. 12 example, the trigger travel path 611 can be collinear to the trigger travel axis 499.

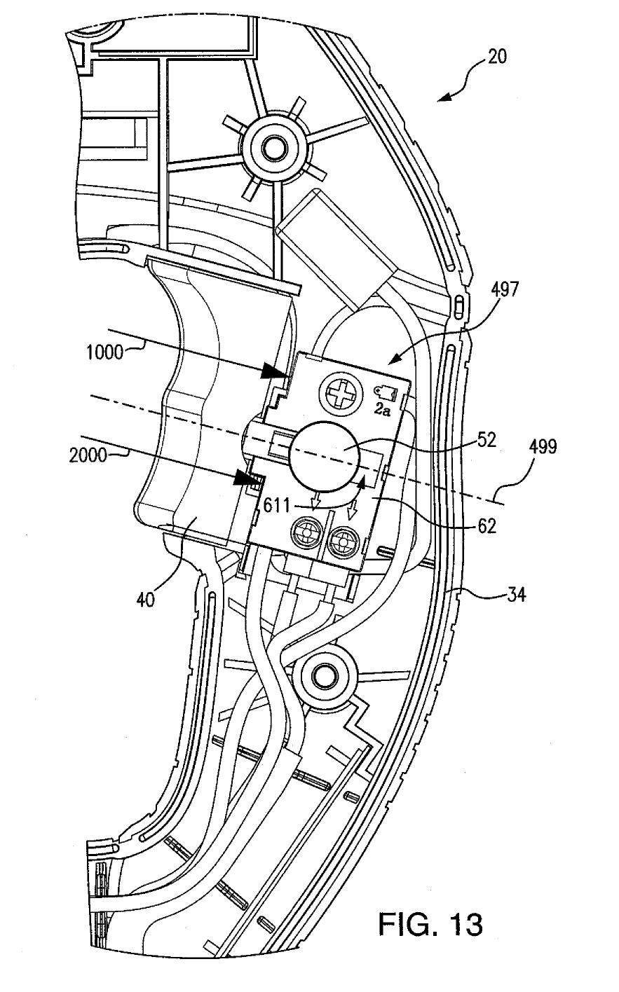

FIG. 13 is a sectional side view of the compact handle showing a trigger being depressed. This figure shows the trigger switch of FIG. 12 being switched by the movement of the trigger 40 along the travel path 611 and along the trigger travel axis 499. In this example, the movement of trigger 40 can be caused by the gripping of the index finger 225 and pulling in the direction of arrow 1000 to depress the switch assembly 497, as well as the gripping of the middle finger 245 and pulling in the direction of arrow 2000. This movement can depress the switch assembly 497 and cause the switch assembly to achieve a depressed state.

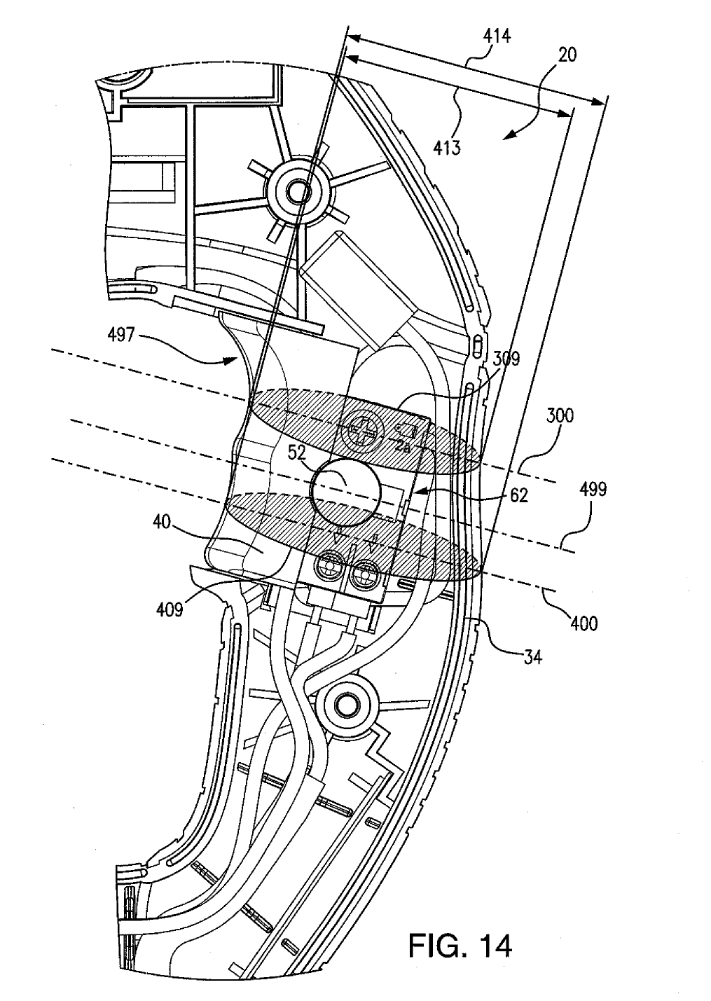

FIG. 14 is a sectional side view of the compact handle 34 showing the trigger 40 in a depressed state. In this example, the trigger 40 is configured adjacent to the trigger switch 62 in the depressed state of the switch assembly 497.

The compact switch assembly for a power tool can have a switch assembly 497 which has a ratio of a switch assembly width when the compact switch assembly is in its depressed state to a trigger travel in a range of 25:1 to 1.05:1, or in a range of 20:1 to 1.25:1, or in a range of 10:1 to 1.5:1.

The compact switch assembly can have a switch assembly 497 which has a ratio of a switch assembly width when the compact switch assembly is in its depressed state to a trigger travel of less than 20:1, or less than 2:1, or less than 1.9:1, or less than 1.8:1, or less than 1.7:1, or less than 1.6:1, or less than 1.5:1, or less than 1.4:1, or less than 1.3:1, or less than 1.2:1, or in a range of 20:1 to 5:1, or 15:1 to 5:1, or 10:1 to 5:1; having a ratio such as for example: 16:1, or 10:1, or 9:1, or 7:1, or 6:1, or 5:1, or 4:1, or 3:1 or 2:1, or 1.5:1, or 1.25:1, or 1.05:1.

FIG. 14 shows an upper grip perimeter 310, which can have an upper extended grip perimeter 311 and an upper depressed grip perimeter 312. The upper grip perimeter 310 can have a value in a range from 20 mm to 300 mm, or 20 mm to 50 mm, or 25 mm to 45 mm, or 25 mm to 40 mm, or 25 mm to 35 mm, or 50 mm to 300 mm, or 50 mm to 250 mm, or 50 mm to 200 mm, or 50 mm to 150 mm, or 50 mm to 75 mm, or 50 mm to 60 mm; having a value such as for example: 50 mm, or 55 mm, or 60 mm, or 65 mm, or 70 mm, or 75 mm, or 100 mm, or 120 mm, or 122 mm, or 125 mm, or 150 mm, or 175 mm, or 200 mm. In an embodiment, the upper grip perimeter can have a greater value than the upper depressed grip perimeter.

FIG. 14 also shows an upper depressed grip width 413 and a lower depressed grip width 414. In an embodiment, the upper depressed grip width 413 can have a value of from 15 mm to 50 mm, or 15 mm to 40 mm, or 15 mm to 30 mm, or 15 mm to 25 mm, or 15 mm to 20 mm; having a value such as for example: 30 mm, or 32 mm, or 34 mm, or 35 mm, or 36 mm, or 38 mm, or 40 mm, or 42 mm, or 45 mm, or 48 mm. In an embodiment, the lower depressed grip width 414 can have a value of from 15 mm to 50 mm, or 15 mm to 40 mm, or 15 mm to 30 mm, or 15 mm to 25 mm, or 15 mm to 20 mm; having a value such as for example: 30 mm, or 32 mm, or 34 mm, or 35 mm, or 36 mm, or 38 mm, or 40 mm, or 42 mm, or 45 mm, or 48 mm.

FIG. 14 shows the upper depressed grip circumference 309 and the lower depressed grip circumference 400.

FIG. 15 is a sectional side view of the compact handle showing an average extended upper grip volume 570 and an average extended lower grip volume 580. There is no limitation as to how fine the integration of the grip volumes can be calculated. In the example of FIG. 15, the extended upper grip volume 570 can be calculated by computing an upper grip cross sectional area 575 times the upper trigger length 576 plus a lower grip cross sectional area 585 times the lower trigger length 586. In an embodiment, the upper grip cross sectional area 575 can be in a range or from 500 mm̂2 to 3000 mm̂2, or 500 mm̂2 to 2000 mm̂2, or 500 mm̂2 to 1500 mm̂2, or 500 mm̂2 to 1250 mm̂2, or 500 mm̂2 to 1000 mm̂2, or 500 mm̂2 to 750 mm̂2; having a value such as for example: 1000 mm̂2, or 1250 mm̂2, or 1500 mm̂2, or 1700 mm̂2, or 2000 mm̂2. In an embodiment, the lower grip cross sectional area 585 can be in a range or from 500 mm̂2 to 3000 mm̂2, such as 1000 mm̂2, or 1250 mm̂2, or 1500 mm̂2, or 1700 mm̂2, or 2000 mm̂2.

FIG. 15 also shows an upper extended grip width 306 and a lower extended grip width 406.

FIG. 16 is a sectional side view of the compact handle showing an average extended grip volume. The example of FIG. 16 is an example of an average extended grip volume 510. In an embodiment, the average extended grip volume 510 can be calculated by multiplying the average cross sectional area 550 in an extended state by the length of the trigger 40. The average depressed grip volume can be calculated by multiplying the average cross sectional area 550 in a depressed state by the length of the trigger 40.

In the example of FIG. 16, the cross average cross sectional area 550 can be determined by using an average grip radius 434 or an average grip diameter 436. The cross average cross sectional area 550 can also be determined from a rigorous calculation of the grip assembly 599 geometry.

FIG. 16 shows the average grip perimeter 435. The average upper grip volume 490 and average lower grip volume 500 are also shown.

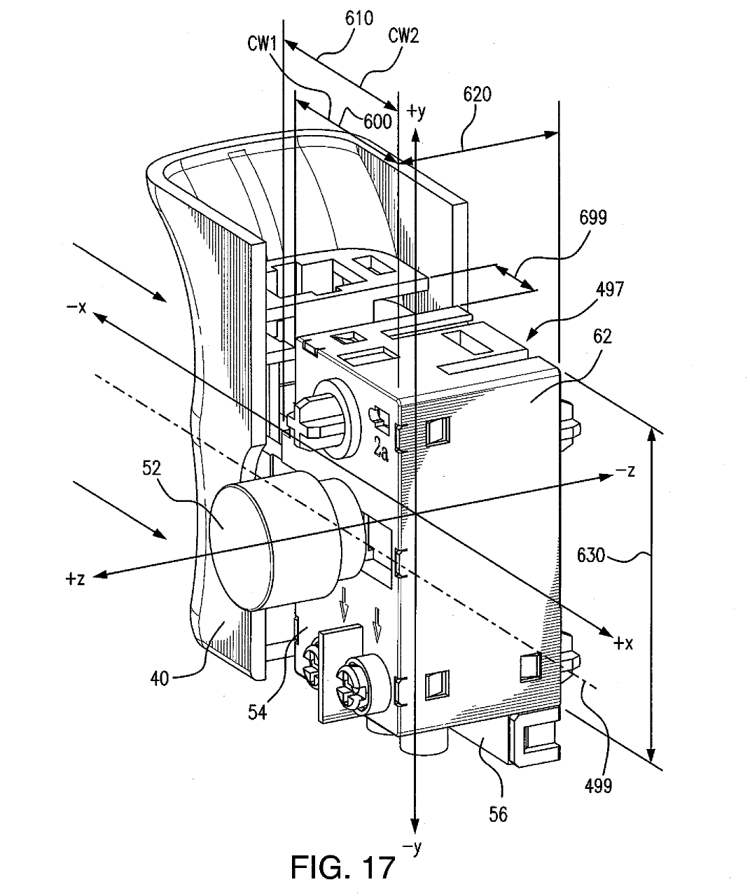

FIG. 17 is a perspective view of a switch assembly 497 in an extended state. FIG. 17 shows a switch assembly 497 having a trigger assembly in an extended state. The switch assembly 497 has a switch depth 620 and a switch length 630. In the example embodiment of FIG. 17, the switch assembly 497 has a switch cover 54 having a first switch cover width 600 (also herein as “CW1”) and a second switch cover width 610 (also herein as “CW2”). The first switch cover width 600 can be shorter than the second switch cover width 610. The example embodiment of FIG. 17 has a trigger travel distance 699 (also herein as “D”; also as “trigger travel 699”). The configuration of the FIG. 17 embodiment accommodates a trigger travel distance 699 which allows the trigger to be seated against portions of the trigger switch 62 when the switch assembly 497 in a depressed stated. For example the trigger can be configured adjacent to the first switch cover width 600 and/or adjacent to the second switch cover width 610 when the switch assembly 497 in a depressed stated (FIG. 18).

FIG. 18 is a perspective view of a trigger assembly in a depressed state. FIG. 18 shows switch assembly in a depressed state. The example of FIG. 18 shows the trigger 40 depressed against the trigger switch 62.

FIG. 18 also shows the configuration of the first grip plane 302, the lower grip plane 402, as well as the handle plane 340. In the example embodiment of FIG. 18, the upper grip plane 302 and the lower grip plane 402 are parallel to one another and also parallel to the trigger travel plane 519 which can be coplanar to the trigger travel axis in the X-Z plane. In the embodiment of FIG. 18, the handle plane 340 can be perpendicular to the upper grip plane 302 and the lower grip plane 402 and can be coplanar to the trigger travel axis 499 in the Y-X plane.

In the embodiment of FIG. 18, a user can grip the grip assembly 599 having switch assembly 497 and use index finger 225 to depress the trigger 40 by applying pressure to index finger notch 382 and also use middle finger 245 to depress the trigger 40 by applying pressure to middle finger notch 386. These pressures can depress the trigger 40 and move it along its trigger travel axis 499 and along its trigger travel distance 699 toward trigger switch 62 and to switch trigger 62 to an “on” state.

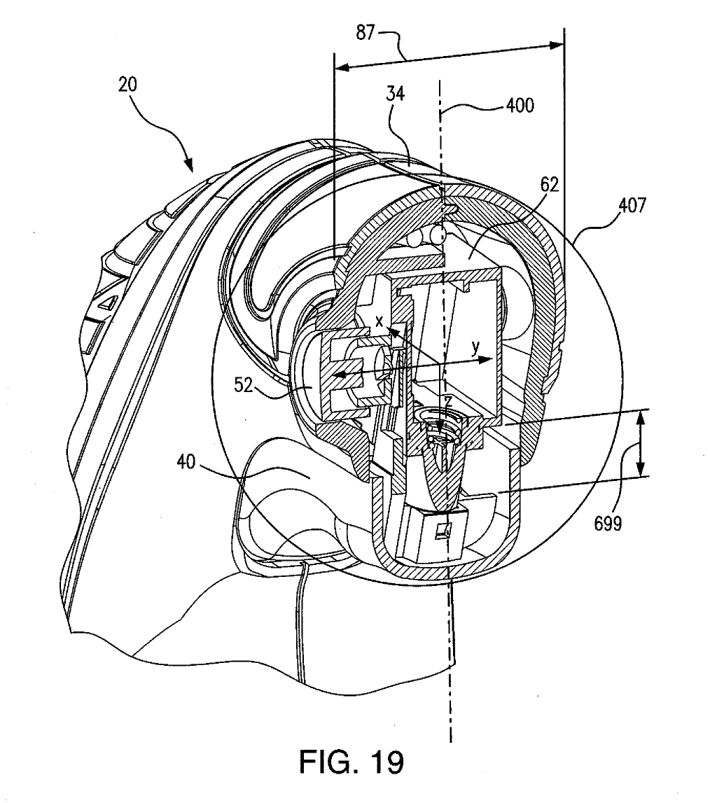

FIG. 19 is a sectional view of the compact handle 34 taken across a lower grip plane 402 and showing the lower extended grip circumference 407. The depression of trigger 40 can transition the grip assembly to a lower depressed switch circumference as the trigger switch 62 is triggered. In the embodiment of FIG. 19 the lower extended grip circumference 407 is shown, as well as a handle cross sectional width 87. In an embodiment the handle cross sectional width 87 can have a value of from 10 mm to 80 mm, or 10 mm to 70 mm, or 10 mm to 60 mm, or 10 mm to 50 mm, or 10 mm to 40 mm, or 10 mm to 30 mm, or 10 mm to 25 mm, or 10 mm to 20 mm; having a value such as for example: 20 mm, or 25 mm, or 30 mm, or 38 mm, or 40 mm, or 50 mm, or 60 mm.

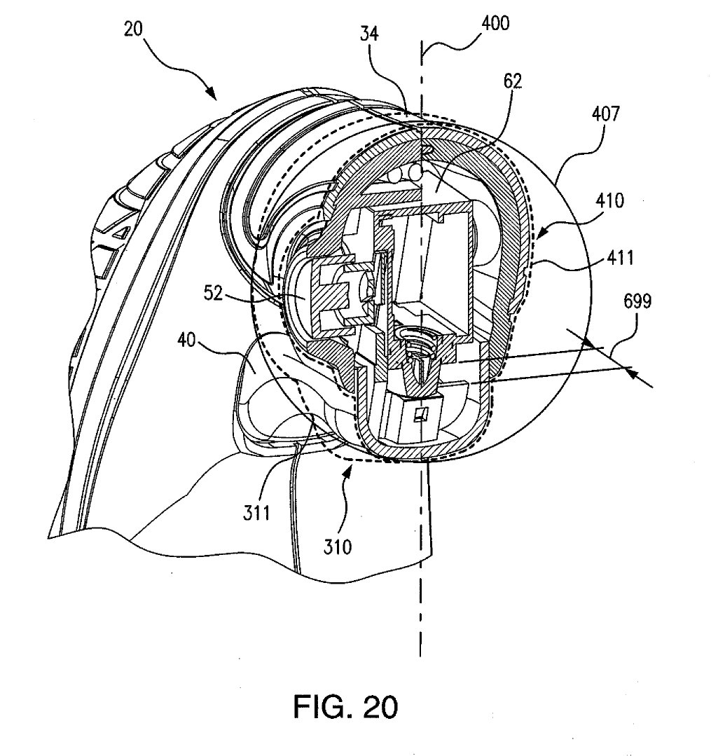

FIG. 20 is a sectional view of the compact handle taken across a lower grip plane and showing a lower extended trigger perimeter. FIG. 20 shows the upper grip perimeter 310 and the lower grip perimeter 410. FIG. 20 has a cross sectional view which illustrates how lower grip perimeter 410 in this example encompasses a section cut of the grip assembly 599 and the switch assembly 497.

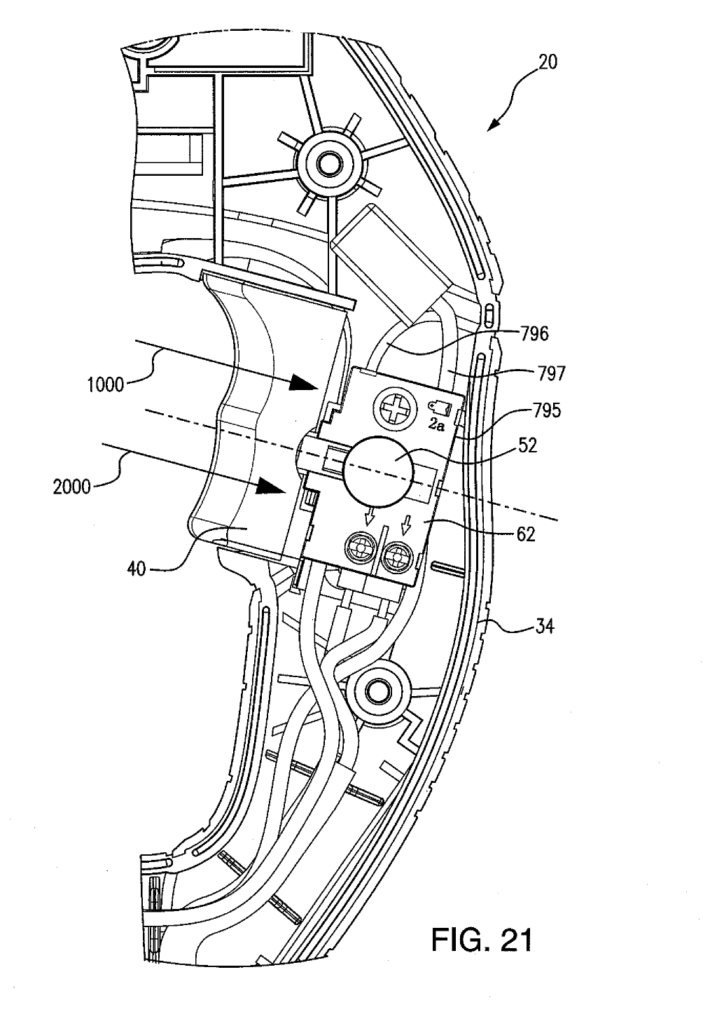

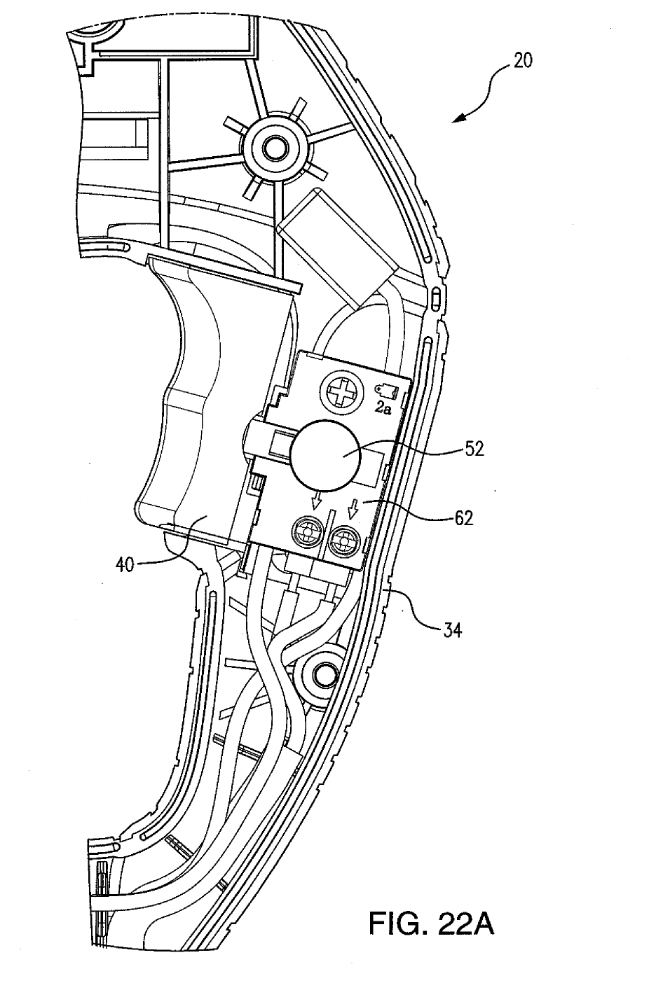

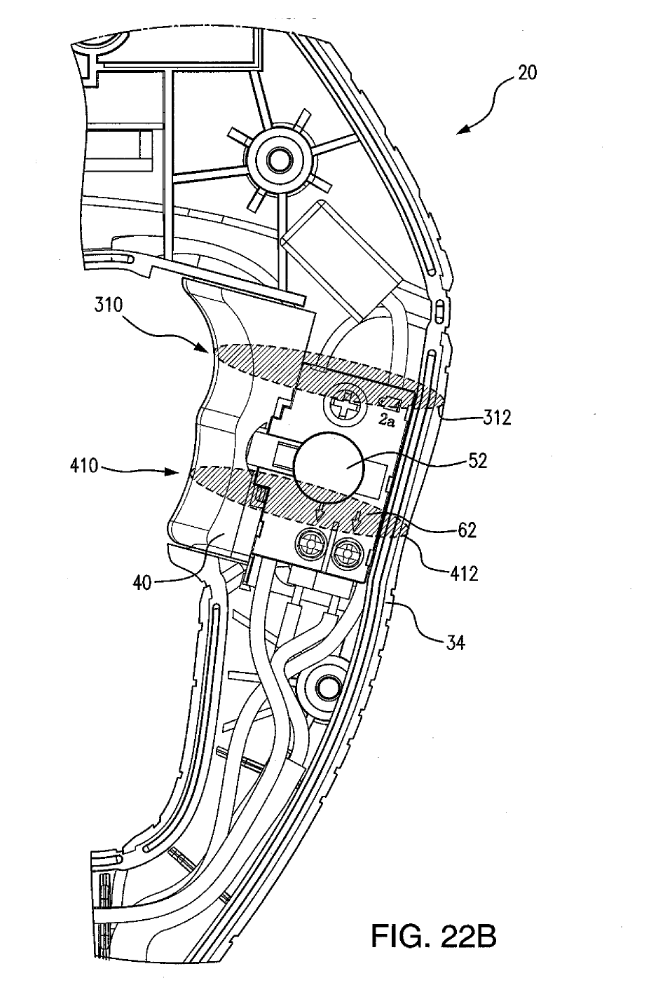

FIG. 20 shows a lower grip perimeter 410, which can range in length from a lower extended grip perimeter 411 to a lower depressed grip perimeter 412 (FIG. 22B). The a lower grip perimeter 410 can range from 300 mm to 20 mm, or 300 mm to 50 mm, or 250 mm to 100 mm, or 200 mm to 100 mm, or 175 mm to 100 mm, or 165 mm to 100 mm, or 160 mm to 100 mm, or 250 mm to 50 mm, or 200 mm to 50 mm, or 175 mm to 50 mm, or 150 mm to 50 mm, or 100 mm to 50 mm, or 75 mm to 50 mm; having a value such as for example: 75 mm, or 100 mm, or 120 mm, or 125 mm, or 129 mm, or 150 mm, or 175 mm, or 200 mm.

FIG. 20 shows an upper grip perimeter 310, which can range in length from a lower extended grip perimeter 311 to a lower depressed grip perimeter 312 (FIG. 22B). The lower grip perimeter 410 can range from 300 mm to 20 mm, or 300 mm to 50 mm, or 250 mm to 100 mm, or 200 mm to 100 mm, or 175 mm to 100 mm, or 165 mm to 100 mm, or 160 mm to 100 mm, or 250 mm to 50 mm, or 200 mm to 50 mm, or 175 mm to 50 mm, or 150 mm to 50 mm, or 100 mm to 50 mm, or 75 mm to 50 mm; having a value such as for example: 75 mm, or 100 mm, or 120 mm, or 125 mm, or 129 mm, or 150 mm, or 175 mm, or 200 mm.

In embodiments, the lower extended grip perimeter 411 can have a greater value, lesser value or equal value to the upper extended grip perimeter 311. In embodiments, the lower extended grip perimeter 412 can have a greater value, lesser value or equal value to the upper extended grip perimeter 312.

FIG. 21 is a sectional side view of the compact handle showing a trigger having a compact wiring configuration. For non-limiting example, the first wire 796 and the second wire 797 are configured so as to not interfere with the configuration of the handle closely encompassing adjacent to the end side 795 of the trigger switch 62.

FIG. 22A is a sectional side view of the compact handle configured closely around in the plane of the end side 795 of the trigger switch 62. In the example of FIG. 22A, the switch assembly 497 is shown in its extended state.

FIG. 22B is a sectional side view of the compact handle configured closely around in the plane of the end side 795 of the trigger switch 62. In the example of FIG. 22B, the switch assembly 497 is shown in its depressed state. FIG. 22B also shows an upper grip perimeter 310, which can have an upper depressed grip perimeter 312, as well as a lower grip perimeter 410, which can have a lower depressed grip perimeter 412.

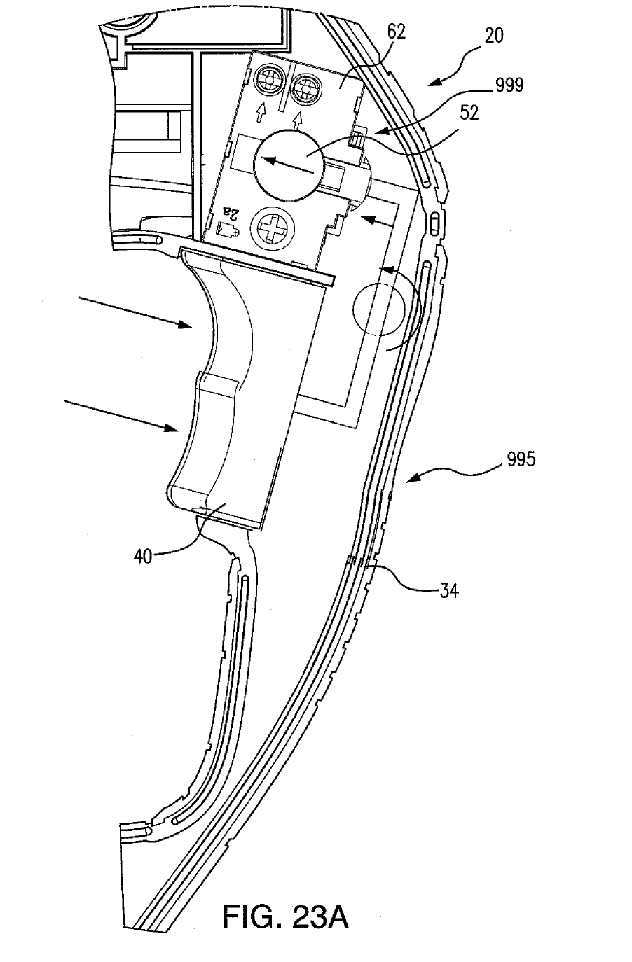

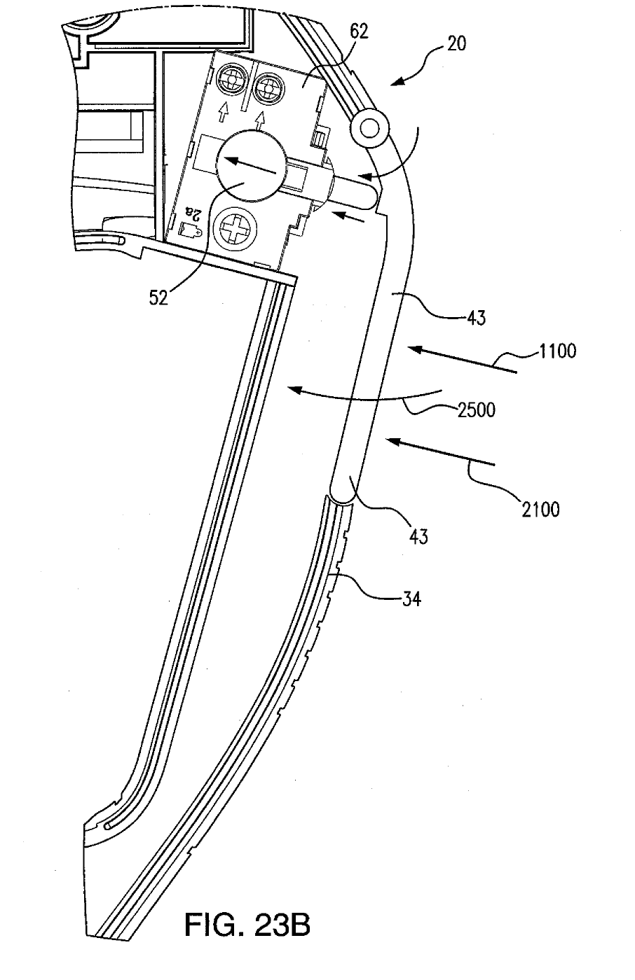

FIG. 23A is a sectional view of the compact handle having a pocketed AC switch 999, such as the AC compact variable speed switch 449, and a handle 34 which is a thin handle 995. In an embodiment, placing the switch assembly 497 at least in part in the head portion 36 and/or aft portion 38 and/or body of the power tool achieves a configuration having a thin handle 995.

FIG. 23B shows a compact handle 34 having a compression trigger 43. In the embodiment of FIG. 23B, the power tool 20 has a pocketed AC switch 999, such the AC compact variable speed switch 449, and the compression trigger 43 which is triggered by at least a portion of the palm 290 of hand 199 depressing the compression trigger 43 in the direction of arrow 1100 and arrow 2100. In an embodiment, the compression trigger 43 is pivotally attached to the power tool 20 and the movement of the trigger is rotational as shown by arrow 2500.

FIG. 23C shows a compact handle 34 having a pull lever trigger 47. In the embodiment of FIG. 23C a switch assembly 467, such as the AC compact variable speed switch 449, can be a pull lever trigger 47, which triggers the switch assembly 467, when depressed by a user in the direction of arrow 2550. In an embodiment, the compression trigger 43 is pivotally attached to the power tool 20 and the movement of the trigger is rotational as shown by arrow 2550.

In an embodiment, the compact handle 34 can have a compact handle having a motor direction selector.

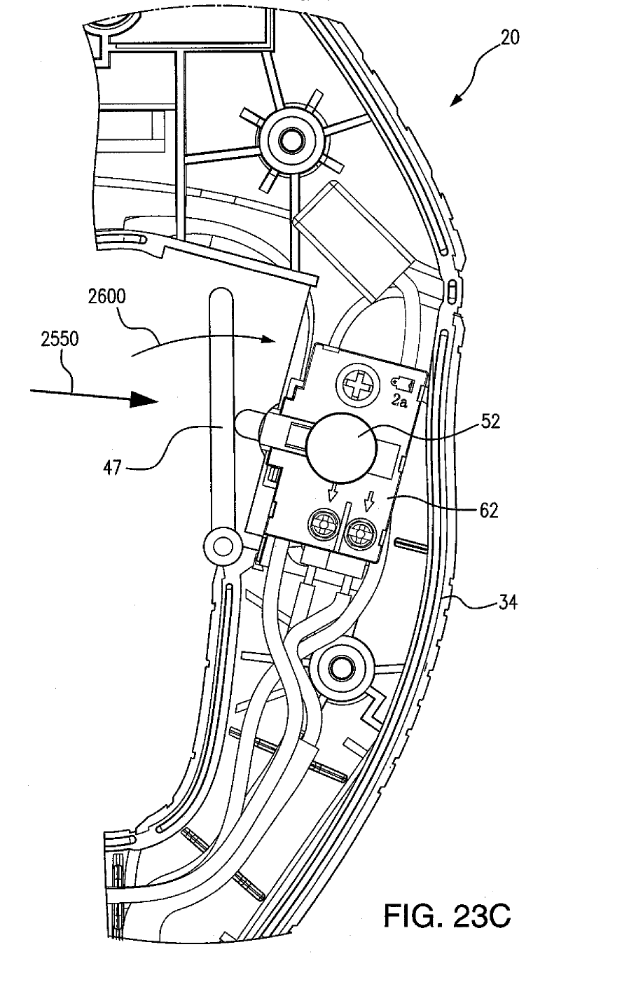

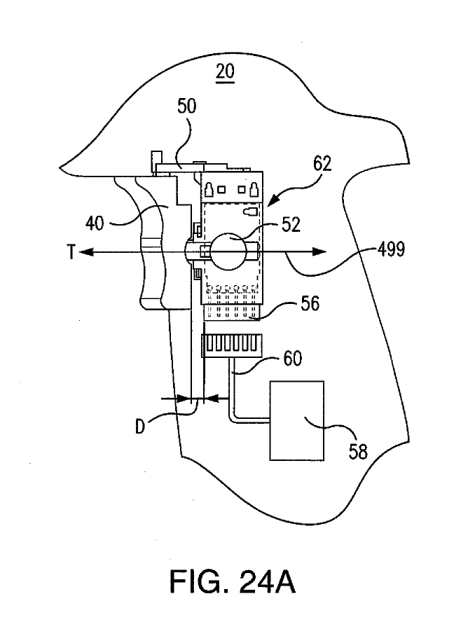

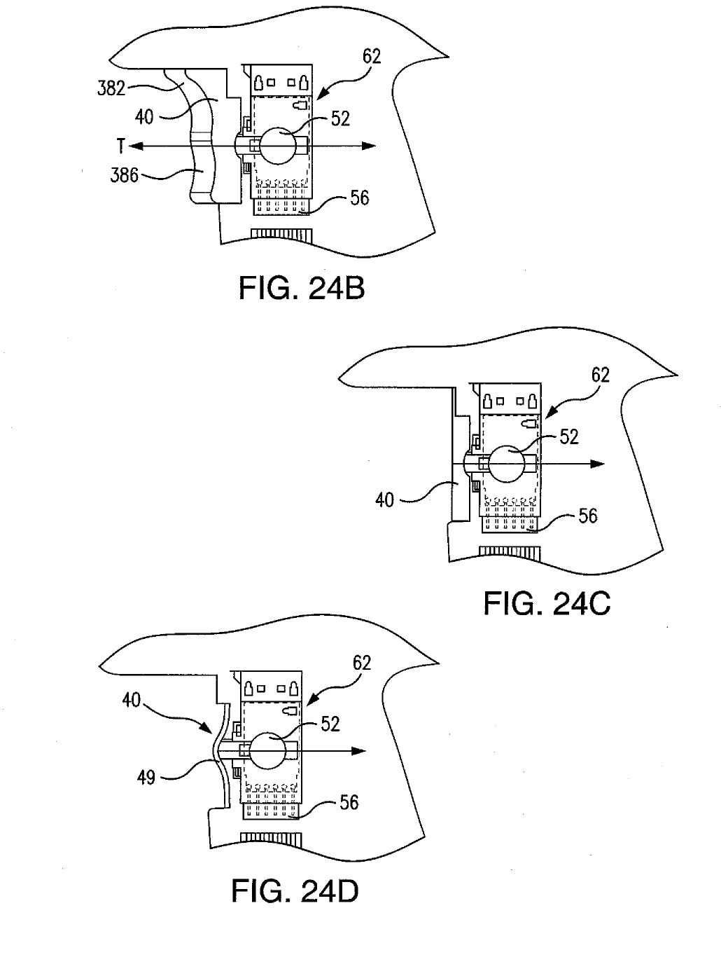

FIGS. 24A-D show a non-limiting number of variations of the trigger 40. The trigger 40 can be any mechanism which is moved by a portion of the hand 199, such as a finger or fingers or palm, and which switches the switch assembly 497.

FIG. 24A shows a compact handle having an AC switch, such as such the AC compact variable speed switch 449, and a microprosser 58 connected by a multi-wire cable 60 to a pin connector 56 of the switch assembly 497. Optionally, the switch assembly 497 can have a motor direction selector 50.

In an embodiment, the axis of trigger travel 499 (or T) can intersects the trigger 40 when the trigger 40 is in the extended position and when the trigger 40 is in the depressed position such that the trigger 40 moves linearly along the axis of trigger travel 499. The trigger 40 also defines a trigger travel distance D extending from the extended position to the depressed position. Accordingly, the trigger travel distance D is measured along the axis of trigger travel 499 and is the distance between the extended position of the trigger 40 and the depressed position of the trigger 40. In other words, the trigger travel distance D can be described as the length of pull or the stroke length of the trigger 40. The handheld power tool 21 can optionally include the motor direction selector 50. The motor direction selector 50 is movably received in the compact handle 34 for movement between a forward position and a reverse position. The forward position and the reverse position can correspond to the direction of rotation of the electric motor 28 and/or driven tool piece. The trigger lock 52 can engages the trigger 40 in the locked position to limit movement of the trigger 40 along the axis of trigger travel 499. Accordingly, the trigger 40 can be locked in the depressed position such that the electric motor 28 can be maintained in the powered state without the user applying continuous pressure to the trigger 40. Alternatively, the trigger 40 can be locked in the extended position such that inadvertent activation of the electric motor 28 to the powered state can be avoided. The structure of the trigger lock 52 can take a variety of forms. In an embodiment, the trigger lock 52 can have a push-button connected to a pin that engages a hole formed in the trigger 40.

FIG. 24B shows a compact handle having an AC switch. The trigger 40 of FIG. 24B is an embodiment having one or more finger notches, such as index finger notch 382 and middle finger notch 386.

FIG. 24C shows a compact handle having a trigger 40 with a flattened face. This can in an embodiment be a thin trigger 40 having a gripping portion which is low-profile and/or flattened.

FIG. 24D shows a compact handle having a trigger 40 which is a low profile trigger 44. The low profile trigger 44 can be a flexible portion of the handle 34, or a diaphragm, or rubber part, or plastic cover or laminate, or any member which allows a portion of a hand and/or finger to move it to switch the switch assembly 497.

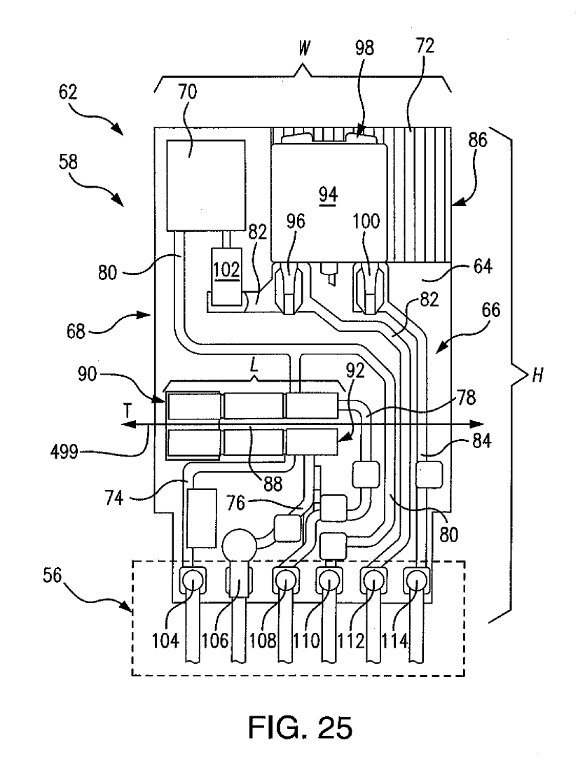

FIG. 25 is a side elevation view of the exemplary compact AC switch and illustrates a printed circuit board. In the example embodiment of FIG. 25.

FIG. 25 shows a trigger switch 62 for use in conjunction with the microprocessor 58. The trigger switch 62 is disposed within the trigger switch cover 54. The trigger switch 62 can include a printed circuit board 64 having a first face 66 and a second face 68. The first face 66 of the printed circuit board 64 generally has an input connection 70 and an output connection 72 and a plurality of conductive traces 74, 76, 78, 80, 82, 84 interconnecting the input connection 70 and the output connection 72. The second face 68 of the printed circuit board 64 is thermally coupled to a heat sink plate 86. The printed circuit board 64 has a width W measurable along the axis of trigger travel 499 and a height H measurable in a direction that is transverse to the axis of trigger travel 499. The printed circuit board 64 need not be rectangular in shape as shown in FIG. 25, but can take a variety of different shapes. The width W of the circuit board is not necessarily the overall width of the printed circuit board 64 as measured at its widest point, but is simply the width W of the printed circuit board 64 as measured along the axis of trigger travel 499. As such, the width W of the printed circuit board 64 necessarily corresponds to a region of the printed circuit board 64 adjacent the trigger 40.

The trigger switch 62 includes a variable resistor 88 mounted to the first face 66 of the printed circuit board 64. The variable resistor 88 is electrically connected to the input connection 70 of the printed circuit board 64. The variable resistor 88 is also disposed in sliding engagement with the trigger 40 along the axis of trigger travel 499. As such, the variable resistor 88 controls the motor speed of the electric motor 28 in accordance with position of the trigger 40 in relation to the variable resistor 88. The variable resistor 88 has an outboard end 90 and an inboard end 92. The outboard end 90 of the variable resistor 88 generally corresponds to the extended position of the trigger 40 and the inboard end 92 of the variable resistor 88 generally corresponds to the depressed position of the trigger 40. The variable resistor has a predetermined length L extending between the outboard end 90 and the inboard end 92. However, the predetermined length L of the variable resistor 88 is slightly larger than the trigger travel distance D.

The trigger switch 62 also includes a triac 94 mounted to the first face 66 of the printed circuit board 64. The triac 94 has a first terminal 96, a second terminal 98, and a third terminal 100. The trigger switch 62 also includes a current shock resistor 102 mounted to the first face 66 of the printed circuit board 64. FIG. 25 shows a plurality of pins 104, 106, 108, 110, 112, 114 that extend through the trigger switch cover 54 to form the pin connector 56.

In the embodiment shown in FIG. 25, the predetermined length L of the variable resistor 88 is approximately 8.75 mm and the trigger travel distance D can be approximately 7 mm. The width W of the printed circuit board 64 can be approximately 16 mm and the height H of the printed circuit board 64 can be approximately 24.4 mm.

Advantageously, the width W of the printed circuit board 64 is reduced allowing for a thinner compact handle 34 with improved ergonomics. This benefit improves the use of space within the housing 32 and the compact handle 34 and allows for new packaging configurations of handheld power tools 20 that were not previously obtainable.

The foregoing description of the aspects of the present teachings has been provided for purposes of illustration and description. It is not intended to be exhaustive or to limit the disclosure. Individual elements or features of a particular aspect are generally not limited to that particular aspect, but, where applicable, are interchangeable and can be used in a selected aspect, even if not specifically shown or described. The same can also be varied in many ways. Such variations are not to be regarded as a departure from the disclosure, and all such modifications are intended to be included within the scope of the disclosure. In some example aspects, well-known processes, well-known device structures, and well-known technologies are not described in detail.

The terminology used herein is for the purpose of describing particular example aspects of the present teachings only and is not intended to be limiting. As used herein, the singular forms “a,” “an,” and “the” is/are intended to include the plural forms as well, unless the context indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

Although the terms first, second, third, etc. can be used herein to describe various elements, components, regions, layers and/or sections, these elements, components, regions, layers and/or sections should not be limited by these terms. These terms can be only used to distinguish one element, component, region, layer, or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, can be used herein for ease of description to describe one element or feature's relationship to another element(s) or feature(s) as illustrated in the figures. Spatially relative terms can be intended to encompass different orientations of the device in use or operation in addition to the orientation depicted in the figures. For example, if the device in the figures is turned over, elements described as “below” or “beneath”, or “upper” or “lower”, other elements or features would then be oriented “above” or “upper” the other elements or features. Thus, the example term “below” or “lower” can encompass both an orientation of above, or upper, and below, or lower. The device can be otherwise oriented (rotated degrees or at other orientations) and the spatially relative descriptors used herein interpreted accordingly. These antecedent recitations should be interpreted to cover any combination in which the inventive novelty exercises its utility.

This scope disclosure is to be broadly construed. It is intended that this disclosure disclose equivalents, means, systems and methods to achieve the devices, activities and mechanical actions disclosed herein. For each device, mechanical element or mechanism disclosed, it is intended that this disclosure also encompass in its disclosure and teaches equivalents, means, systems, processes and methods for practicing the many aspects, mechanisms and devices disclosed herein. Additionally, this disclosure regards a power tool having a compact handle and its many aspects, features and elements. Such a compact handle can be dynamic in its use an operation, this disclosure is intended to encompass the equivalents, means, systems and methods of the use of the tool and its many aspects consistent with the description and spirit of the operations and functions disclosed herein. The claims of this application are likewise to be broadly construed.

The description of the inventions herein in their many embodiments is merely exemplary in nature and, thus, variations that do not depart from the gist of the invention are intended to be within the scope of the invention. Such variations are not to be regarded as a departure from the spirit and scope of the invention.

We claim:

1. A power tool, comprising:
a handle having a grip portion which is configured at a distance from a body portion providing a finger clearance between said grip portion and said body portion;
a handle having a trigger which triggers an AC compact variable switch which controls the speed of a motor; and
said handle having a handle width of 60 mm or less measured along a trigger travel axis.

2. The power tool according to claim 1, further comprising:
a switch assembly which comprises the trigger which triggers the AC compact variable switch;
said switch assembly having an extended state in which the trigger is in an extended position and a depressed state in which the trigger is depressed at least in part along a trigger travel distance;
said handle width having a value of 50 mm or less when said switch assembly is in said depressed state.

3. The power tool according to claim 2, wherein said handle width has a value of 40 mm or less when said switch assembly is in said depressed state.

4. The power tool according to claim 2, wherein said handle width has a value of 60 mm or less when said switch is in said extended state and said handle width has a value of 40 mm or less when said switch assembly is in said depressed state.

5. The power tool according to claim 2, wherein said a finger clearance is 50 mm or less measured along a grip axis.

6. The power tool according to claim 2, wherein the handle height is 100 mm or less measured along a grip axis of a grip assembly; said grip assembly containing at least a portion of said AC compact variable switch;
said handle having a handle width which is 50 mm or less measured along a grip axis when said switch assembly is in said depressed state;
said switch assembly having a trigger travel axis which passes through said trigger and said AC compact variable switch; and
said switch assembly having a trigger travel distance which is 3 mm or greater.

7. The power tool according to claim 1, wherein said handle has an average depressed grip volume of 75000 mm̂3 or less (75 cm̂3 or less).

8. The power tool according to claim 1, wherein said handle further comprises a wireless communication device which transmits data regarding the power tool.

9. A jigsaw, comprising
a handle having a switch assembly which activates an electric motor which drives a jigsaw blade driving mechanism;
said switch assembly having a trigger and an AC compact variable switch;
said switch assembly having an extended state and a depressed state;
when said switch assembly is in said extended state the trigger is in an extended configuration and at an extended position along a trigger travel path, when said switch assembly is in said extended state an extended grip width is 55 mm or less; and
when said switch assembly is in said depressed state the trigger is in an depressed configuration and at a depressed position along a trigger travel path, when said switch assembly is in said depressed state a depressed grip width is 50 mm or less.

10. The jigsaw according to claim 9, wherein when said switch assembly is in said extended state an extended grip width is in a range of 50 mm to 35 mm, and when said switch assembly is in said depressed state an depressed grip width is in a range of 45 mm to 28 mm.

11. The jigsaw according to claim 9, further comprising a depressed grip perimeter of 155 mm or less.

12. The jigsaw according to claim 9, further comprising a trigger travel distance which is in a range of from 3 mm to 20 mm.

13. The jigsaw according to claim 9, further comprising a handle height of 80 mm or less.

14. The jigsaw according to claim 9, further comprising a grip depression having a grip depression height of 1 mm or greater.

15. The jigsaw according to claim 9, further comprising a distance between a portion of the grip depression and a portion of the AC compact variable switch which is 15 mm or less.

16. The jigsaw according to claim 9, further comprising a grip depression having a grip depression height in a range of 1 mm to 10 mm.

17. A jigsaw, comprising:
a handle having a switch assembly which has an AC compact variable switch;
said handle having a depressed grip width of 60 mm or less;
said handle having a trigger grip low point; and
a finger clearance of 10 mm or greater measured between said trigger grip low point and a closest portion of a jigsaw body upper surface to said trigger grip low point.

18. The jigsaw according to claim 17, further comprising an electric motor housed in the jigsaw body; and
a jigsaw blade driving mechanism driven by the electric motor; and
wherein the switch assembly comprises a trigger which triggers the AC compact variable speed switch, said switch assembly having an extended state in which the trigger is in an extended position and a depressed state in which the trigger is depressed at least in part along a trigger travel distance; and
wherein said handle has an extended handle width value of 55 mm or less when the trigger is in the extended position; and
wherein the handle has a depressed grip width of 50 mm or less when the trigger is depressed.

19. The jigsaw according to claim 18, wherein said handle has an extended handle width value of 50 mm or less when the trigger is in the extended position;
wherein the trigger travel distance between the extended state and the depressed state is at least 4 mm; and
wherein said handle has a depressed grip perimeter of 155 mm or less.

20. The jigsaw according to claim 19, further comprising a trigger lock movably received in said handle that moves between a locked position and an unlocked position wherein said trigger lock engages said trigger in said locked position to limit movement of said trigger along said axis of trigger travel.
